(19) United States
(12) Patent Application Publication
(10) Pub. No.: US 2026/0320317 A1
(43) Pub. Date: Oct. 15, 2026

(54) APPARATUS FOR AND METHOD OF DATA PROCESSING BASED ON ARTIFICIAL INTELLIGENCE

(71) Applicant: Solos Technology Limited, Cambridge, MA (US)

(72) Inventors: Chi Sum Yu, Shatin N.T. (HK); Wai Kuen Cheung, Shatin N.T. (HK); Kenneth Fan, Cambridge, MA (US); Kwok Wah Law, Shatin N.T. (HK)

(73) Assignee: Solos Technology Limited, Cambridge, MA (US)

(21) Appl. No.: 19/706,936

(22) Filed: Jun. 12, 2026

Related U.S. Application Data
(63) Continuation-in-part of application No. 18/581,417, filed on Feb. 20, 2024.

(30) Foreign Application Priority Data
Sep. 20, 2023 (CN) 202311222742.4

(51) Int. Cl. G06F 40/58; G10L 15/25; H04R 1/02

(52) U.S. Cl. CPC G06F 40/58; G10L 15/25; H04R 1/028; H04R 2499/15

(57) ABSTRACT

An apparatus for and method of audio processing are disclosed. The apparatus leverages artificial intelligence and includes an audio input component, a display component, at least a processor, and a memory communicatively connected to the at least a processor. The audio input component detects audio data. The processor receives the audio data and generates text content as a function of the audio data. The processor determines a display target for at least a portion of the text content and displays the at least a portion of the text content by the display component at the display target.

### CROSS-REFERENCE TO RELATED APPLICATIONS

This application is a continuation-in-part of U.S. Non-Provisional patent application Ser. No. 18/581,417, filed on Feb. 20, 2024, and entitled “TRANSLATION SYSTEM, SMART GLASSES FOR TRANSLATION, AND TRANSLATION METHOD BASED ON ARTIFICIAL INTELLIGENCE,” which claims priority to Chinese Patent Application No. 202311222742.4, filed on Sep. 20, 2023, each of which is hereby incorporated by reference herein as if set forth in its entirety.

### FIELD OF THE INVENTION

The present invention generally relates to the field of intelligent devices. In particular, the present invention is directed to an apparatus for and a method of data processing based on artificial intelligence.

### BACKGROUND

With the development of computer technology, smart devices, such as smart glasses, are becoming more and more popular. However, existing smart devices are expensive, and in addition to their own specific functions, they usually only have limited functionality and lack versatility.

### SUMMARY OF THE DISCLOSURE

In some aspects, the techniques described herein relate to an apparatus for audio processing. The apparatus includes an audio input component configured to detect audio data, a display component, at least a processor, and a memory communicatively connected to the at least a processor, wherein the memory contains instructions configuring the at least a processor to: receive the audio data from the audio input component, generate text content as a function of the audio data, determine a display target for at least a portion of the text content, and display at least a portion of the text content by the display component at the display target.

In some aspects, the techniques described herein relate to a method of audio processing. The method includes detecting, using an audio input component, audio data, receiving, using at least a processor, the audio data from the audio input component, generating, using the at least a processor, text content as a function of the audio data, determining, using the at least a processor, a display target for at least a portion of the text content, and displaying, using the at least a processor, at least a portion of the text content by a display component at the display target.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a schematic structural diagram of a translation system based on artificial intelligence (AI) according to one embodiment of the present disclosure;

FIG. 2 illustrates a scenario diagram of the translation system shown in FIG. 1;

FIG. 3 illustrates a schematic structural diagram of the translation system based on AI according to another embodiment of the present disclosure;

FIG. 4 illustrates a schematic diagram of a first system framework based on the translation system shown in FIGS. 1 and 3;

FIG. 5 illustrates a schematic diagram of a second system framework based on the translation system shown in FIGS. 1 and 3;

FIG. 6 illustrates a schematic diagram of a third system framework based on the translation system shown in FIGS. 1 and 3;

FIG. 7 illustrates a schematic diagram of a fourth system framework based on the translation system shown in FIGS. 1 and 3;

FIG. 8 illustrates a schematic diagram of an internal structure of smart glasses for translation based on AI according to one embodiment of the present disclosure;

FIG. 9 illustrates a schematic diagram of an external structure of the smart glasses shown in FIG. 8;

FIG. 10 illustrates a flow diagram of a translation method based on AI according to one embodiment of the present disclosure;

FIG. 11 illustrates a schematic diagram of implementing a first translation mode in the translation system shown in FIG. 1 and the translation method shown in FIG. 10;

FIG. 12 illustrates a schematic diagram of implementing a second translation mode in the translation system shown in FIG. 1 and the translation method shown in FIG. 10;

FIG. 13 illustrates a schematic diagram of implementing a third translation mode in the translation system shown in FIG. 1 and the translation method shown in FIG. 10;

FIG. 14 illustrates a schematic diagram of implementing a fourth translation mode in the translation system shown in FIG. 1 and the translation method shown in FIG. 10;

FIG. 15 illustrates a block diagram of an exemplary apparatus for audio processing;

FIG. 16 illustrates a block diagram of an exemplary machine-learning module;

FIG. 17 illustrates a diagram of an exemplary neural network;

FIG. 18 illustrates a block diagram of an exemplary node in a neural network;

FIG. 19 illustrates a flow diagram of an exemplary method of data processing; and

FIG. 20 illustrates a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus for and method of data processing. In some aspects, the techniques described herein relate to an apparatus for audio processing. The apparatus includes an audio input component configured to detect audio data; a display component; at least a processor; and a memory communicatively connected to the at least a processor, wherein the memory contains instructions configuring the at least a processor to: receive the audio data from the audio input component; generate text content as a function of the audio data; determine a display target for at least a portion of the text content; and display at least a portion of the text content by the display component at the display target.

The present disclosure provides a translation system, smart glasses for translation, and a translation method based on artificial intelligence (AI), which aim to realize the high precision translation based on the smart glasses, thereby improving the practicality, interactivity and intelligence of the smart glasses, and increasing the user stickiness in and/or affinity to the product.

An embodiment of the present disclosure provides a translation system based on artificial intelligence (AI), including first smart glasses, a first smart mobile terminal and a cloud server, wherein the cloud server is configured with a multimodal model including but not limited to large language model (LLM), and the LLM comprises a generative artificial intelligence large language model or a multimodal large language model, the first smart glasses are used to pick up a first speech in a first language from a preset direction, and send the first speech to the first smart mobile terminal via Bluetooth, the first smart mobile terminal is used to convert the first speech into a first text using a speech-to-text engine, and send the first text to the cloud server, wherein the speech-to-text engine is configured in the first smart mobile terminal or cloud, the cloud server is used to translate, through the multimodal model and/or LLM, the first text to obtain a second text in a second language according to a translation prompt, and send the second text to the first smart mobile terminal, the first smart mobile terminal is further used to convert the second text into a second speech using a text-to-speech engine, and send the second speech to the first smart glasses, wherein the text-to-speech engine is configured in the first smart mobile terminal or cloud, and the first smart glasses are further used to play the second speech.

An embodiment of the present disclosure provides smart glasses for translation based on AI, including a speech pickup device, an output device, a processor and a memory, wherein the processor is electrically connected to the speech pickup device, the output device and the memory, one or more computer programs executable on the processor are stored in the memory, and the one or more computer programs include instructions to pick up a first speech in a first language from a preset direction through the speech pickup device, translate, through a large language model (LLM) configured in the local or cloud, the first speech to obtain a second speech in a second language, wherein the LLM comprises a generative artificial intelligence model or a multimodal large language model, and output the second speech through the output device.

An embodiment of the present disclosure provides a translation method based on AI, applied to a smart mobile terminal, including receiving a first speech in a first language sent by a smart wearable device, converting the first speech into a first text using a speech-to-text engine configured in the local or cloud, and obtaining a translation prompt, translating, through a large language model (LLM) configured in the local or the cloud, the first text to obtain a second text in a second language according to the translation prompt, wherein the LLM comprises a generative artificial intelligence large language model or a multimodal large language model, and converting the second text into a second speech using a text-to-speech engine configured in the local or the cloud, and sending the second speech to the smart wearable device for playback.

In some of the embodiments of the present disclosure, by combining the smart glasses, the smart mobile terminal and the server, the intelligent translation based on the smart glasses is realized, thereby improving the practicality, interactivity and intelligence of the smart glasses, and increasing the user stickiness in and/or affinity to the product. Furthermore, due to the scalability and self-creativity of the LLM, the accuracy of the translation can be further improved.

The present disclosure provides a translation system, smart glasses for translation, and a translation method based on artificial intelligence (AI), which aim to realize the high precision translation based on the smart glasses, thereby improving the practicality, interactivity and intelligence of the smart glasses, and increasing the user stickiness in the product.

An embodiment of the present disclosure provides a translation system based on artificial intelligence (AI), including first smart glasses, a first smart mobile terminal and a cloud server, wherein the cloud server is configured with a large language model (LLM), and the LLM comprises a generative artificial intelligence large language model or a multimodal large language model, the first smart glasses are used to pick up a first speech in a first language from a preset direction, and send the first speech to the first smart mobile terminal via Bluetooth, the first smart mobile terminal is used to convert the first speech into a first text using a speech-to-text engine, and send the first text to the cloud server, wherein the speech-to-text engine is configured in the first smart mobile terminal or cloud, the cloud server is used to translate, through the LLM, the first text to obtain a second text in a second language according to a translation prompt, and send the second text to the first smart mobile terminal, the first smart mobile terminal is further used to convert the second text into a second speech using a text-to-speech engine, and send the second speech to the first smart glasses, wherein the text-to-speech engine is configured in the first smart mobile terminal or cloud, and the first smart glasses are further used to play the second speech.

An embodiment of the present disclosure provides smart glasses for translation based on AI, including a speech pickup device, an output device, a processor and a memory, wherein the processor is electrically connected to the speech pickup device, the output device and the memory, one or more computer programs executable on the processor are stored in the memory, and the one or more computer programs include instructions to pick up a first speech in a first language from a preset direction through the speech pickup device, translate, through a large language model (LLM) configured in the local or cloud, the first speech to obtain a second speech in a second language, wherein the LLM comprises a generative artificial intelligence large language model or a multimodal large language model, and output the second speech through the output device.

An embodiment of the present disclosure provides a translation method based on AI, applied to a smart mobile terminal, including receiving a first speech in a first language sent by a smart wearable device, converting the first speech into a first text using a speech-to-text engine configured in the local or cloud, and obtaining a translation prompt, translating, through a large language model (LLM) configured in the local or the cloud, the first text to obtain a second text in a second language according to the translation prompt, wherein the LLM comprises a generative artificial intelligence large language model or a multimodal large language model, and converting the second text into a second speech using a text-to-speech engine configured in the local or the cloud and sending the second speech to the smart wearable device for playback.

In some embodiments of the present disclosure, by combining the smart glasses, the smart mobile terminal and the server, the intelligent translation based on the smart glasses is realized, thereby improving the practicality, interactivity and intelligence of the smart glasses, and increasing the user stickiness in the product. Furthermore, due to the scalability and self-creativity of the LLM, the accuracy of the translation can be further improved.

Exemplary embodiments illustrating aspects of the present disclosure are described below in the context of several specific examples.

In order to make the objects, features and advantages of the present disclosure more obvious and easier to understand, the technical solutions in this embodiment will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

In the following descriptions, the terms “including,” “comprising,” “having” and their cognates that are used in the embodiments of the present disclosure are only intended to represent specific features, numbers, steps, operations, elements, components, or combinations of the foregoing items, and should not be understood as excluding the possibilities of the existence of one or more other features, numbers, steps, operations, elements, components or combinations of the foregoing items or adding one or more features, numbers, steps, operations, elements, components or combinations of the foregoing items.

In addition, in the present disclosure, the terms “first,” “second,” “third,” and the like are only used for distinguishing, and cannot be understood as indicating or implying relative importance.

Unless otherwise defined, all terms (including technical and scientific terms) used herein have the same meanings as commonly understood by those skilled in the art to which the embodiments of the present disclosure belong. The terms (e.g., the terms defined in commonly used dictionaries) will be interpreted as having the same meaning as the contextual meaning in the relevant technology and will not be interpreted as having idealized or overly formal meanings, unless clearly defined in the embodiments of the present disclosure.

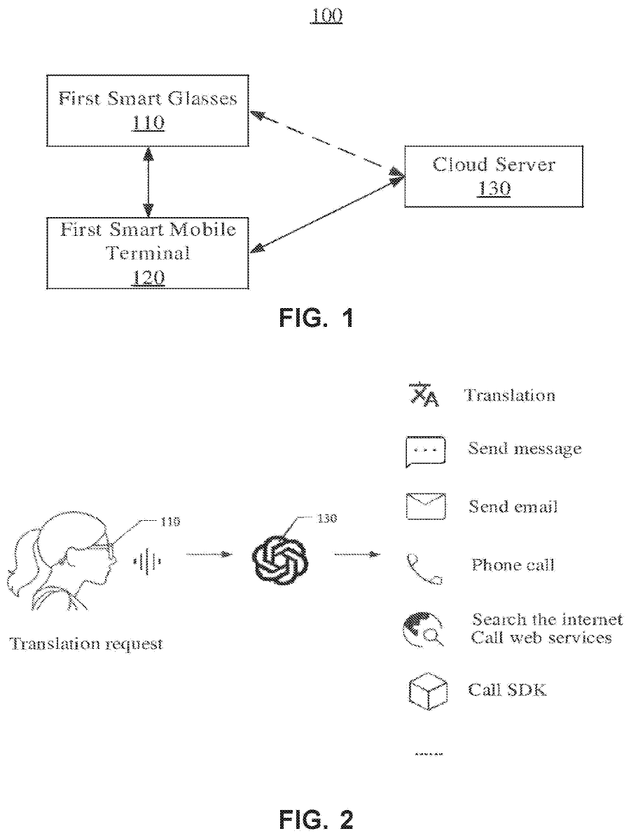

Referring to FIG. 1, a schematic structural diagram of a translation system based on artificial intelligence (AI) according to one embodiment of the present disclosure is illustrated. As shown in FIG. 1, the translation system 100 includes: first smart glasses 110, a first smart mobile terminal 120 and a cloud server 130.

In some embodiments of the present disclosure, a corresponding application (APP) is installed on each smart glasses or each smart mobile terminal. The smart glasses and the smart mobile terminal establish data connection with each other through Bluetooth and use the APP for data interaction.

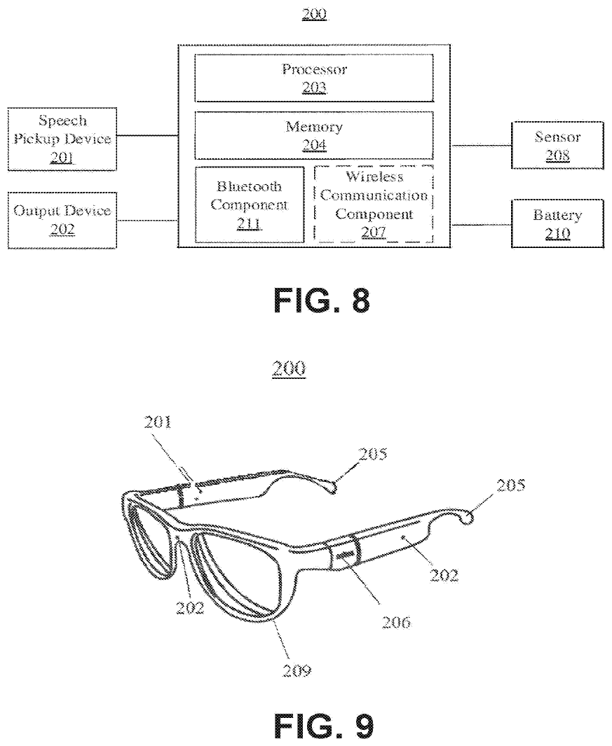

The smart glasses may be open-ear smart glasses, and the specific structure of the smart glasses refer to the relevant descriptions in the following embodiments shown in FIG. 8 and FIG. 9, which is not described here again.

The smart mobile terminal may be include, but is not limited to: cellular phone, smart phone, other wireless communication device, personal digital assistant, audio player, other media player, music recorder, video recorder, camera, other media recorder, smart radio, Laptop computer, personal digital assistant (PDA), portable multimedia player (PMP), Moving Picture Experts Group (MPEG-1 or MPEG-2) audio layer 3 (MP3) player, digital camera, and smart wearable device (such as smart watch, smart bracelet, etc.). An Android, IOS, or operating system is further installed on the smart mobile terminal.

The cloud server 130 may be a single server or a distributed server cluster composed of multiple servers and is configured with at least one Large Language Model (LLM). The LLM may include at least one Generative Artificial Intelligence Large Language Model (GAILLM), or at least one Multimodal Large Language Model (MLLM), or other large language models with similar functions.

The GAILLM may be, for example but not limited to: ChatGPT of Open AI, Bard of Google, and other models with similar functions. The LLM integrates multiple functions of: for example, obtaining the task execution command(s) corresponding to the voice command(s) spoken by the user through natural language (as shown in FIG. 2, send message, send email, phone call, search the Internet, call web services, and call other third-party Software Development Kit (SDK) to perform task(s) provided by the SDK), translation, etc. The part of LLM that obtains the task execution command(s) is trained using a large number of semantics and task execution commands corresponding to the semantics as samples. The part of LLM that is used for translation is trained using a large number of words and/or sentences in the source language and words and/or sentences in the target language corresponding to the words and/or sentences in the source language as samples. One source language may correspond to several different target languages.

Specifically, in some embodiments, the first smart glasses 110 are used to: pick up a first speech in a first language (i.e., source language) from a preset direction and send the first speech to the first smart mobile terminal 120 via Bluetooth. Optionally, the preset direction may point to the front of a user of the first smart glasses 110, that is, a listening mode, and in the listening mode, the language spoken by the chat partner of the user of the first smart glasses 110 is the source language. Alternatively, the preset direction may point to the mouth of the user of the first smart glasses 110, that is, a talking mode, and in the talking mode, the language spoken by the user of the first smart glasses 110 is the source language. In response to a voice command of the user, or an action of the user pressing the control button on the first smart glasses 110 which is used for switching the translation mode, or action(s) of the user in a User Interface (UI) of the first smart mobile terminal 120, the first smart glasses 110 switch the current translation mode to a corresponding mode. Furthermore, the source language and target language are determined according to the current translation mode.

In some embodiments, the first smart mobile terminal 120 is used to: convert the first speech into a first text using a speech-to-text engine and send the first text to the cloud server 130. The speech-to-text engine is configured in the first smart mobile terminal 120 or cloud (such as, a speech-to-text server, a model server, a translation server, or other cloud server).

In some embodiments, the cloud server 130 is used to: translate, through the LLM, the first text to obtain a second text in a second language (i.e., the target language) according to a translation prompt and send the second text to the first smart mobile terminal 120.

In some embodiments, the first smart mobile terminal 120 is further used to: convert the second text into a second speech using a text-to-speech engine and send the second speech to the first smart glasses 110 via Bluetooth. The text-to-speech engine is configured in the first smart mobile terminal 120 or cloud (such as, a text-to-speech server, the model server, the translation server, or other cloud server).

In some embodiments, the first smart glasses 110 are further used to play the second speech.

The translation prompt may include instruction information for instructing the LLM to perform a translation task. Furthermore, the translation prompt further includes: identification information of the first language and/or the second language. The translation prompt may be generated by a prompt generator. The prompt generator may be a software module or a microcontroller configured with the software module and is used to generate corresponding prompt information according to the parsed semantics in the user speech, where the semantics are obtained by parsing each user speech. Alternatively, the prompt generator may generate the translation prompt according to other preset rules, for example, receiving a translation instruction, receiving a text sent by a specific object, receiving data containing identification information of the language, etc.

The prompt generator may be configured in the smart glasses 110, the first smart mobile terminal 120, or any server in the cloud.

Optionally, in one embodiment of the present disclosure, the prompt generator obtains identification information of the first language and/or the second language from the smart glasses 110 or the first smart mobile terminal 120.

Optionally, in other embodiments of the present disclosure, the first smart mobile terminal 120 is further used to generate the translation prompt and send the translation prompt to the cloud server 130.

Optionally, in other embodiments of the present disclosure, a mobile application (APP) is installed on the first smart mobile terminal 120.

In some embodiments, the first smart mobile terminal 120 is further used to: in response to a preset action of a user, send, through the mobile APP, a translation instruction to the first smart glasses 110. The preset action may be, for example, but not limited to, any one of the following actions: the user pressing a virtual button preset on the UI of the mobile APP which is used for starting translation, the user performing one or more preset sliding gestures on the screen of the first smart glasses 110 or the first smart mobile terminal 120, the user pressing a translation control button provided on the temple(s) of the first smart glasses 110, and the user speaking a preset translation voice command, etc.

In some embodiments, the first smart glasses 110 are further used to: enter a translation mode in response to the translation instruction and pick up the first speech from the preset direction in the translation mode.

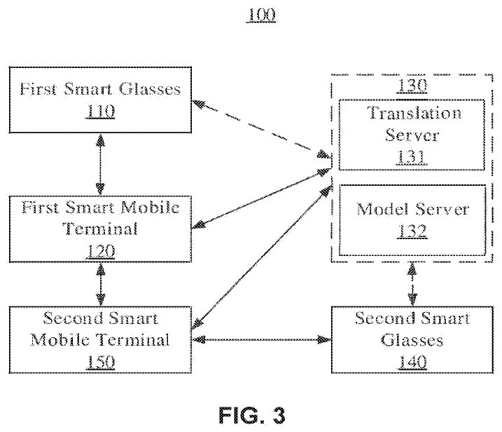

Optionally, in other embodiments of the present disclosure, as shown in FIG. 3, a mobile APP is installed on the first smart mobile terminal 120, the cloud server 130 includes a translation server 131 and a model server 132 (or it can also be called LLM server), and the LLM is configured in the model server 132.

In some embodiments, the first smart mobile terminal 120 is further used to, in response to a user pressing a button on a screen of the first smart mobile terminal 120, send a speech picking up instruction to the first smart glasses 110 through the mobile APP. The button is generated by the mobile APP.

In some embodiments, the first smart glasses 110 are further used to pick up the first speech from the preset direction in response to the speech picking up instruction.

In some embodiments, the first smart mobile terminal 120 is further used to, in response to the user releasing the button, send the first text to the translation server 131 through the mobile APP.

In some embodiments, the translation server 131 is used to: generate the translation prompt and send the first text and the translation prompt to the model server 132.

In some embodiments, the model server 132 is used to: translate, through the multimodal model and/or LLM, the first text to obtain the second text according to the translation prompt and send the second text to the translation server 131.

In some embodiments, the translation server 131 is further used to send the second text to the first smart mobile terminal 120.

Optionally, in other embodiments of the present disclosure, as shown in FIG. 3, the cloud server 130 includes a translation server 131 and a model server 132, a mobile APP is installed on the first smart mobile terminal 120, and the LLM is configured in the model server 132.

In some embodiments, the first smart glasses 110 are further used to, in response to a user pressing a virtual button on a temple of the first smart glasses 110, pick up the first speech from the preset direction.

In some embodiments, the first smart glasses 110 are further used to, in response to the user releasing the virtual button, send a notification message to the mobile APP via Bluetooth.

In some embodiments, the first smart mobile terminal 120 is further used to send, through the mobile APP, the first text to the translation server 131 according to the notification message.

In some embodiments, the translation server 131 is used to: generate the translation prompt and send the first text and the translation prompt to the model server 132.

In some embodiments, the model server 132 is used to: translate, through the LLM, the first text to obtain the second text according to the translation prompt and send the second text to the translation server 131.

In some embodiments, the translation server 131 is further used to send the second text to the first smart mobile terminal 120.

Optionally, in other embodiments of the present disclosure, a mobile APP is installed on the first smart mobile terminal 120, and the first smart mobile terminal 120 is further used to: generate, through the mobile APP, translation transcript(s) according to the second text, or the first text and the second text, and display the translation transcript(s) on a screen of the first smart mobile terminal 120; and save, through the mobile APP, the translation transcript(s) on the first smart mobile terminal 120 or a storage server.

Optionally, in other embodiments of the present disclosure, the first smart mobile terminal 120 is further used to: in response to an action of a user performed on a sharing button on the UI of the mobile APP being detected, sharing, through the mobile APP, the translation transcript(s) according to a sharing manner indicated by the action.

The sharing may be, for example but not limited to: sharing the translation transcript(s) with the friend(s) of the first smart glasses 110 registered in instant messaging software such as WeChat; or sharing the translation transcript(s) with other terminal equipment via the email; or sharing the translation transcript(s) on social networking platform(s), such as Facebook, Instagram, etc. The user can view the translation transcript(s) on a sharing terminal in the form of full translation or comparison between the original text and the translation. Some or all of the translation transcript(s) generated during one or more translation periods specified by the user can be shared. A process of smart glasses from entering translation mode to exiting translation mode can be regarded as one translation period.

Optionally, in other embodiments of the present disclosure, a mobile APP is installed on the first smart mobile terminal 120, and the first smart mobile terminal 120 is further used to: generate, through the mobile APP, the second speech with a preset playback speed, and send the second speech with the preset playback speed to the first smart glasses 110 for playback via the Bluetooth.

Optionally, in other embodiments of the present disclosure, a mobile APP is installed on the first smart mobile terminal 120.

In some embodiments, the first smart mobile terminal 120 is further used to set up the second language according to a setting action performed by a user through the mobile APP.

In some embodiments, the first smart glasses 110 are further used to: perform a speech picking up action and send the picked-up speech to the first smart mobile terminal 120 in real time via Bluetooth in a form of data stream.

In some embodiments, the first smart mobile terminal 120 is further used to: detect whether a language of the received speech is the first language using the speech-to-text engine; in response to the language being the first language, send a starting translation instruction to the first smart glasses 110 via the Bluetooth, convert the received speech as the first speech into a first text through the speech-to-text engine, and send the first text and the translation prompt to the model server 132, wherein the translation prompt includes information of the first language and the second language; and in response to a silence of a preset duration being detected, send a stopping translation instruction to the first smart glasses 110 via the Bluetooth,

In some embodiments, the first smart glasses 110 are further used to: enter a translation mode in response to the starting translation instruction; and in response to the stopping translation instruction, exit the translation mode and end the speech picking up action.

Specifically, in some embodiments, after smart glasses are powered on or according to a listening instruction triggered by a user, the smart glasses perform a speech picking up action to listen a user speech in real time and send the real-time listened speech to the smart mobile terminal in the form of data stream. The real-time listened speech is cached in the memory of the smart glasses. During the listening, the smart glasses use the multiple threads to overwrite the old speech with the newly picked-up speech of the preset duration continuously in the memory (for example, overwrite the previously picked-up voice of 3 seconds with the currently picked-up speech of 3 seconds), and simultaneously send the cached newly picked-up speech to the smart mobile terminal. The smart mobile terminal stores the received speech in the local memory and determines whether the language of the received speech is the first language. On the one hand, when the language is not the first language, the smart mobile terminal deletes the received speech from the local memory, and continues to perform the action of determining whether the language of the received speech is the first language based on the newly received speech, until no new speech sent by the smart glasses is received for a preset time period, or until receiving a notification message of stopping listen sent by the smart glasses On the other hand, when the language is the first language, the smart mobile terminal sends a starting translation instruction to the smart glasses, and performs the translation action on the received speech. The smart glasses enter the translation mode according to the starting translation instruction and continue to perform the speech picking up action. Furthermore, when a silence of a preset duration is detected in the speech stored in the local memory, the smart mobile terminal sends a stopping translation instruction to the smart glasses, so that the smart glasses exit the translation mode and end the speech picking up action according to the stopping translation instruction.

Optionally, in other embodiments of the present disclosure, as shown in FIG. 3, the cloud server 130 includes a translation server 131 and a model server 132, and the LLM is configured in the model server 132.

In some embodiments, the first smart glasses 110 are further used to send the first speech to the translation server 131 via a wireless network.

In some embodiments, the translation server 131 is used to: convert the first speech into a first text using a speech-to-text engine, generate a translation prompt, and send the first text and the generated translation prompt to the model server 132.

In some embodiments, the model server 132 is used to: translate, through the LLM, the first text to obtain the second text according to the translation prompt and send the second text to the translation server 131.

In some embodiments, the translation server 131 is further used to: convert the second text into a second speech using a text-to-speech engine and send the second speech to the first smart glasses 110 via the wireless network.

Optionally, in other embodiments of the present disclosure, the preset direction points to the mouth of the user of the first smart glasses 110. As shown in FIG. 3, the translation system 100 further includes second smart glasses 140 and a second smart mobile terminal 150.

In some embodiments, the first smart mobile terminal 120 is further used to send the second speech to the second smart mobile terminal 150.

In some embodiments, the second smart mobile terminal 150 is used to send the second speech to the second smart glasses 140.

In some embodiments, the second smart glasses 140 is used to play the second speech.

Optionally, in other embodiments of the present disclosure, the first smart mobile terminal 120 is further used to: generate, through a mobile APP on the first smart mobile terminal 120, translation transcript(s) in real time according to the first text and the second text, store the translation transcript(s) in the first smart mobile terminal 120, display the translation transcript, and synchronize the translation transcript(s) to the second smart mobile terminal 150.

In some embodiments, the second smart mobile terminal 150 is further used to: store the translation transcript(s) in the second smart mobile terminal 150 and display the translation transcript(s) through a mobile APP on the second smart mobile terminal 150.

Specifically, in some embodiments, the mobile APP on the second smart mobile terminal 150 displays the translation transcript(s) in a form of list on the screen of the second smart mobile terminal 150. The user of the second smart mobile terminal 150 views different parts of the translation transcript(s) by: performing a preset scrolling gesture on the screen or using physical or virtual button(s) on the second smart mobile terminal 150, or the voice control instruction(s).

Optionally, in other embodiments of the present disclosure, as shown in FIG. 3, the cloud server 130 includes a translation server 131, the translation system 100 further includes a plurality of second smart glasses, and the LLM is configured in the translation server 131.

In some embodiments, the first smart glasses 110 are further used to: in response to a user of the first smart glasses 110 pressing a button on a temple of the first smart glasses 110, pick up a first speech of a user of the first smart mobile terminal 120, and send the first speech to the first smart mobile terminal 120 via Bluetooth.

In some embodiments, the first smart mobile terminal 120 is further used to convert, through a mobile APP on the first smart mobile terminal 120, the first speech into a first text using a speech-to-text engine and send the first text to the translation server 131.

In some embodiments, the translation server 131 is used to: generate a first translation prompt, translate, through the LLM, the first text to obtain a plurality of third texts according to the first translation prompt, and distribute each of the third texts to corresponding second smart glasses, wherein a language of each of the third texts corresponds to a language spoken by a user of each of the second smart glasses 140.

In some embodiments, the second smart glasses 140 are used to: convert the received third text into a third speech using a text-to-speech engine and play the third speech.

Optionally, in other embodiments of the present disclosure, the second smart glasses 140 are further used to: in response to a user of the second smart glasses 140 pressing a virtual button on a temple of the second smart glasses 140, pick up a fourth speech of a user of the second smart glasses 140, convert the fourth speech into a fourth text through a speech-to-text engine, and send the fourth text to the translation server 131.

In some embodiments, the translation server 131 is used to: generate a second translation prompt, translate, through the LLM, the fourth text to obtain a fifth text according to the second translation prompt, and send the fifth text to the first smart glasses 110, wherein a language of the fifth text corresponds to a language spoken by a user of the first smart glasses 110.

In some embodiments, the first smart glasses 110 are further used to: convert the fifth text into a fifth speech using a text-to-speech engine and play the fifth speech.

Optionally, in other embodiments of the present disclosure, as shown in FIG. 3, the cloud server 130 includes a translation server 132, and the LLM is configured in the model server 132.

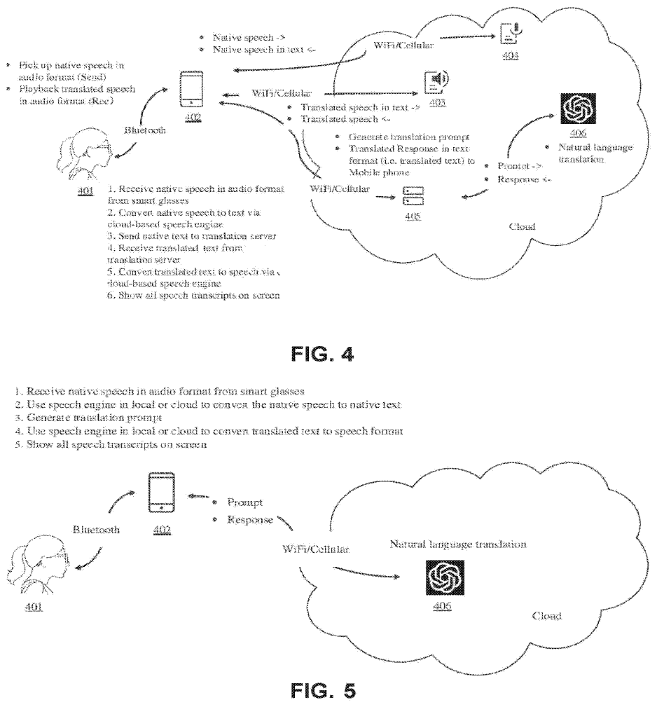

Referring to FIG. 4, a schematic diagram of a first system framework based on the translation system shown in FIGS. 1 and 3 is illustrated. As shown in FIG. 4, in some embodiments, the translation system includes: smart glasses 401, a smart mobile terminal 402, a text-to-speech server 403, a speech-to-text server 404, a translation server 405 and a model server 406. A text-to-speech engine is configured in the text-to-speech server 403, a speech-to-text engine is configured in the speech-to-text server 404, a prompt generator is configured in the translation server 405, and a LLM is configured in the model server 406.

In steps 1 to 6 of FIG. 4, when a user presses a virtual button on a temple of the smart glasses 401 worn on the user, the smart glasses 401 pick up a native speech of the user (i.e., the first s) and send the native speech in audio format to a mobile APP on the smart mobile terminal 402. The mobile APP converts the native speech to a native text (i.e., the first text) by data interaction with the speech-to-text server 404, and sends the native text returned by the speech-to-text server 404 to the translation server 405. The translation server 405 generates a translation prompt and send the translation prompt and the native text to the model server 406, so that the model server 406 performs a natural language translation on the native text using LLM according to the translation prompt, and obtains a translated text (i.e., the second text). The translation server 405 receives the translated text returned by the model server 406 and forwards the translated text to the smart mobile terminal 402. The smart mobile terminal 402 converts the translated text into a corresponding speech by data interaction with the text-to-speech server 403, sends the corresponding speech returned by the text-to-speech server 403 to the smart glasses 401 for playback, and simultaneously displays the translated text on the screen of the smart mobile terminal 402.

Referring to FIG. 5, a schematic diagram of a second system framework based on the translation system shown in FIGS. 1 and 3 is illustrated. As shown in FIG. 5, in some embodiments, the translation system includes: smart glasses 401, a smart mobile terminal 402 and a model server 406. A text-to-speech engine, a speech-to-text engine and a prompt generator are configured in the smart mobile terminal 402, and a LLM is configured in the model server 406.

In steps 1 to 5 of FIG. 5, when a user presses a virtual button on a temple of the smart glasses 401 worn on the user, the smart glasses 401 pick up a native speech of the user (i.e., the first s) and send the native speech in audio format to a mobile APP on the smart mobile terminal 402. The mobile APP converts the native speech to a native text (i.e., the first text) by the speech-to-text engine, generates a translation prompt by the prompt generator, and sends the native text and the translation prompt to the model server 406, so that the model server 406 performs a natural language translation on the native text using LLM according to the translation prompt, and obtains a translated text (i.e., the second text). The mobile APP receives the translated text returned by the model server 406, converts the translated text into a corresponding speech by the text-to-speech engine, sends the corresponding speech to the smart glasses 401 for playback, and simultaneously displays the translated text on the screen of the smart mobile terminal 402.

It is understandable that the aforementioned text-to-speech engine and speech-to-text engine can also be configured in one or more cloud servers, and the mobile APP performs the actions of text-to-speech and speech-to-text by data interaction with the one or more cloud servers.

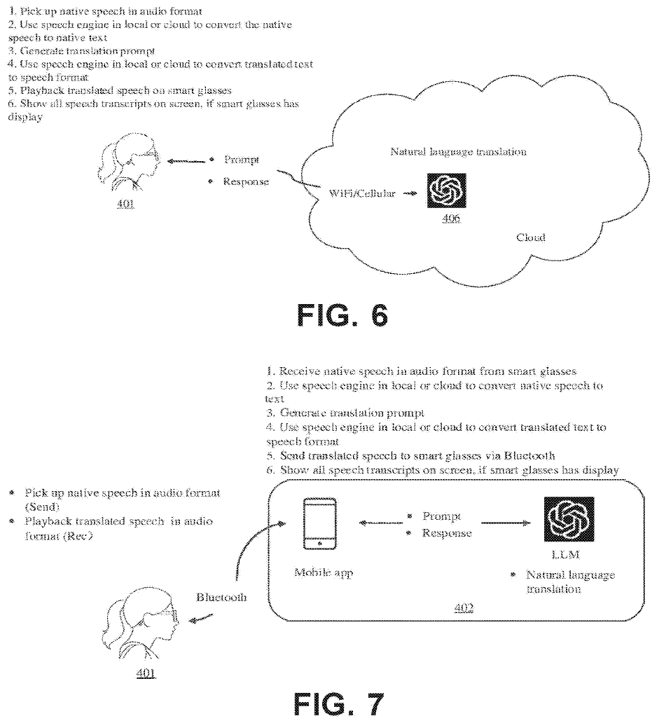

Referring to FIG. 6, a schematic diagram of a third system framework based on the translation system shown in FIGS. 1 and 3 is illustrated. As shown in FIG. 6, in some embodiments, the translation system includes: smart glasses 401 and a model server 406. LLM(s) are configured in the model server 406.

In steps 1 to 6 of FIG. 6, when a user presses a virtual button on a temple of the smart glasses 401 worn on the user, the smart glasses 401 pick up a native speech of the user (i.e., the first speech) through a built-in client APP, convert the native speech into a native text (i.e., the first text) using a speech-to-text engine configured in the local or cloud, generate a translation prompt by a prompt generator configured in the local or cloud, and send the native text and the translation prompt to the model server 406, so that the model server 406 performs a natural language translation on the native text using the LLM(s) according to the translation prompt, and obtains a translated text (i.e., the second text). The smart glasses 401 receive, through the client APP, the translated text returned by the model server 406, convert the translated text into a corresponding speech using a text-to-speech engine configured in the local or cloud, play the corresponding speech, and simultaneously display the translated text on a screen of the smart glasses 401.

For the purposes of this disclosure, “local” is operation within a device or proximate device environment without requiring operation through a remote cloud service. In some embodiments, a local environment may include a processing environment, storage environment, model-execution environment, communication environment, or display environment provided by smart glasses, companion device, a wearable device, a smart terminal, a mobile device, an enterprise edge device, a vehicle compute device, a local server, a local network, or another computing environment associated with a user, participant, enterprise site, vehicle, aircraft, room, or other proximate environment. In some embodiments, a local configuration may include a configuration in which one or more operations are performed within smart glasses, companion device, or another proximate device environment. As a non-limiting example, speech-to-text engine may be executed locally on smart glasses. As another non-limiting example, multimodal model 1564 may be executed locally on companion device, such as a smartphone, smartwatch, another smart glasses, conference-room hub, factory-floor gateway, enterprise Wi-Fi access point, vehicle compute module, aircraft compute module, or enterprise edge device. In some embodiments, a local configuration may include a configuration in which audio data, transcript text, translated text, text content, display target, feedback, audio output, speech-to-text engine, multimodal model, or a language package is processed, stored, generated, displayed, routed, or executed within smart glasses, companion device, or another proximate device environment without requiring transmission to a remote cloud server.

Furthermore, the client APP further generates translation transcript(s) based on the native text and the translated text and allows the user to view the translation transcript(s) on the screen of smart glasses 401 by performing preset action(s). Furthermore, the client APP further shares the translation transcript(s) with other terminal(s) or social networking platform(s) specified by the user according to the sharing voice command of the user.

It is understandable that the aforementioned text-to-speech engine, speech-to-text engine and prompt generator can also be configured in one or more cloud servers, and the client APP performs the actions of text-to-speech, speech-to-text and translation prompt generation by data interaction with the one or more cloud servers.

Referring to FIG. 7, a schematic diagram of a fourth system framework based on the translation system shown in FIGS. 1 and 3 is illustrated. As shown in FIG. 7, in some embodiments, the translation system includes: smart glasses 401 and a smart mobile terminal 402. A text-to-speech engine, a speech-to-text engine, a prompt generator and a LLM are configured in the smart mobile terminal 402.

In steps 1 to 6 of FIG. 7, when a user presses a virtual button on a temple of the smart glasses 401 worn on the user, the smart glasses 401 pick up a native speech of the user (i.e., the first speech) and send the native speech in audio format to a mobile APP on the smart mobile terminal 402. The mobile APP converts the native speech to a native text (i.e., the first text) by the speech-to-text engine, generates a translation prompt by the prompt generator, and inputs the translation prompt and the native text into the LLM, so that the LLM performs a natural language translation on the native text according to the translation prompt, and outputs a translated text (i.e., the second text). The mobile APP converts the translated text into a corresponding speech by the text-to-speech engine, sends the corresponding speech to the smart glasses 401 for playback, and simultaneously displays the translated text on the screen of the smart mobile terminal 402.

Furthermore, when the mobile APP determines that the smart glasses 401 has a screen based on a device information record, the mobile APP sends the translated text to the smart glasses 401 for display on the screen of the smart glasses 401.

Furthermore, the mobile APP further generates translation transcript(s) based on the native text and the translated text and allows the user to view the translation transcript(s) on the screen of the smart glasses 401 or the screen of the smart mobile terminal 402 by performing preset action(s). Furthermore, the mobile APP further shares the translation transcript(s) with other terminal(s) or social networking platform(s) specified by the user, according to the sharing voice command of the user, or the preset sharing action(s) of the user performed on the UI of the mobile APP.

It is understandable that the aforementioned text-to-speech engine, speech-to-text engine and prompt generator can also be configured in one or more cloud servers, and the mobile APP performs the actions of text-to-speech, speech-to-text and translation prompt generation by data interaction with the one or more cloud servers.

In some embodiments, by combining the smart glasses, smart mobile terminal and server, the intelligent translation based on the smart glasses is realized, thereby improving the practicality, interactivity and intelligence of the smart glasses, and increasing the user stickiness in and/or user affinity to the product. Moreover, due to the scalability and self-creativity of the LLM, the accuracy of translation can be further improved.

Referring to FIG. 8 and FIG. 9, FIG. 8 is a schematic diagram of an internal structure of smart glasses for translation based on AI according to one embodiment of the present disclosure, and FIG. 9 is a schematic diagram of an external structure of the smart glasses shown in FIG. 8. For ease of description, only parts related to certain described embodiments of the present disclosure are shown in the figures. In practice, the smart glasses may have more or fewer structures. As shown in FIG. 8, in some embodiments, the smart glasses 200 include: a speech pickup device 201, an output device 202, at least one processor 203 and at least one memory 204.

In some embodiments, the at least one processor 203 is electrically connected to the speech pickup device 201, the output device 202 and the at least one memory 204.

In some embodiments, the speech pickup device 201 includes at least one microphone. Optionally, the speech pickup device 201 includes at least one directional microphone and/or at least one omni-directional microphone. Specifically, the speech pickup device 201 may be a single microphone or a microphone array composed of multiple microphones, for example, a microphone array consisting of at least one directional microphone and/or at least one omni-directional microphone. The output device 202 includes at least one speaker. In one embodiment, the speaker may be configured to playback the audio data, or a corresponding speech based on the transcript text or the translated text.

In some embodiments, the processor 203 includes: a CPU (Central Processing Unit/Processor) and a DSP (Digital Signal Processing). The DSP is used to process the speech data (or the voice data) obtained by the microphone. Preferably, the CPU is a MCU (Micro-controller Unit).

In some embodiments, the memory 204 is a non-transitory memory, and specifically may include: a RAM (Random Access Memory) and a flash memory component. One or more computer programs executable on the processor 203 are stored in the memory 204, and the one or more computer programs include instructions. The instructions are used to: pick up a first speech in a first language from a preset direction through the speech pickup device 201; translate, through a LLM configured in the local or cloud, the first speech to obtain a second speech in a second language; and output, through the output device 202, the second speech.

Optionally, in other embodiments of the present disclosure, the preset direction points to the front of a user.

Optionally, in other embodiments of the present disclosure, a client program is installed on the smart glasses 200, and the instructions are further used to set up the first language and/or the second language according to a first preset action of the user performed on the client program.

Optionally, in other embodiments of the present disclosure, the instructions are further used to set up a playback speed of the second speech according to a second preset action of the user performed on the client program.

Optionally, in other embodiments of the present disclosure, the smart glasses 200 further include a Bluetooth component 211 electrically connected to the processor 203, and the instructions are further used to: receive, by the Bluetooth component 211, a translation instruction sent by a mobile application on a smart mobile terminal, enter a translation mode in response to the translation instruction, and pick up the first speech from the preset direction through the speech pickup device 201 in the translation mode.

In some embodiments, the Bluetooth component 211 includes a Bluetooth signal transceiver and its peripheral circuits and may be specifically provided in an inner cavity of the front frame 209 and/or at least one temple 205. The Bluetooth component 211 can be linked with smart mobile terminals such as smartphones or smart watches, to take phone calls, and music and data communications.

Optionally, in other embodiments of the present disclosure, as shown in FIG. 9, the smart glasses 200 further include: at least one temple 205 and a virtual button 206 provided on the temple 205, the virtual button 206 is based on a touch sensor and is electrically connected to the processor 203, and the instructions are further used to: in response to the user pressing the virtual button, control the speech pickup device 201 to pick up the first speech; in response to the user releasing the virtual button, send, through the Bluetooth component 211, the first speech to the smart mobile terminal, so as to translate, through the smart mobile terminal, the first speech into the second speech using a LLM configured in the smart mobile terminal or a cloud server; and receive, through the Bluetooth component 211, the second speech sent by the smart mobile terminal.

The at least one temple 205 may include, for example, a left temple and a right temple.

Optionally, in other embodiments of the present disclosure, the instructions are further used to: perform, through a speech-to-text engine configured in the local or cloud, a language detection on the first speech to determine whether the first language is a preset language; in response to the first language being the preset language, enter a translation mode, convert, through the speech-to-text engine, the first speech into a first text; generate a translation prompt, and translate, through the LLM, the first text to obtain the second text in the second language, wherein the translation prompt includes information of the first language and the second language; convert, through a text-to-speech engine configured in the local or cloud, the second text into the second speech; and in response to a silence of a preset duration being detected by the speech pickup device 201, exit the translation mode.

Optionally, in other embodiments of the present disclosure, the smart glasses 200 further include a wireless communication component 207 electrically connected to the processor 203, and the instructions are further used to: send, through the wireless communication component 207, the first speech to a translation server, so as to translate, by the translation server, the first speech into the second speech using a LLM configured in the translation server or a model server; and receive, through the wireless communication component 207, the second speech sent by the translation server.

In some embodiments, the wireless communication component 207 includes a wireless signal transceiver and its peripheral circuits and may be specifically provided in an inner cavity of the front frame 209 and/or at least one temple 205 of the smart glasses 200. The wireless signal transceiver may, but is not limited to, use at least one of the Wi-Fi (Wireless Fidelity) protocol, the NFC (Near Field Communication) protocol, the ZigBee protocol, the UWB (Ultra-Wide Band) protocol, the RFID (Radio Frequency Identification) protocol, and the cellular mobile communication protocol (such as 3G/4G/5G, etc.) to perform the data transmission.

Optionally, in other embodiments of the present disclosure, the output device 202 includes front speaker(s), the preset direction points to the front of a user, and the instructions are further used to play the second speech through the front speaker(s).

Optionally, in other embodiments of the present disclosure, the smart glasses 200 further include wireless protocol including, but not limited to, a Bluetooth component 211 electrically connected to the processor 203, the preset direction points to the mouth of a user, and the instructions are further used to send, through one of the wireless protocol including, but not limited to, the Bluetooth component 211, the second speech to an external player for playback. In a non-limiting example, the wireless protocol may include Wi-Fi (Wireless Fidelity) protocol, the NFC (Near Field Communication) protocol, the ZigBee protocol, the UWB (Ultra-Wide Band) protocol, the RFID (Radio Frequency Identification) protocol, and the cellular mobile communication protocol (such as 3G/4G/5G, etc.).

Optionally, in other embodiments of the present disclosure, the smart glasses 200 further include an inertial measurement unit (IMU) sensor 208 electrically connected to the processor 203, and the instructions are further used to: detect whether the first speech ends using a VAD (voice activity detection) algorithm and/or sensing data of the IMU; and in response to the end of the first speech being detected, translate, through the LLM, the first speech to obtain the second speech.

The working principle in some embodiments of the VAD algorithm is to detect whether the user is speaking by detecting changes in the energy of speech. When the user speaks, the energy of the speech will increase, and hence the VAD algorithm can distinguish whether there is voice or no voice by detecting the changes in the energy of speech.

Detecting whether the first speech ends using the sensing data of the IMU sensor, in some embodiments, mainly includes: using the IMU sensor to detect the vibration generated when the user speaks (such as, accelerator), and when the vibration stops for longer than the preset time, it means that the user has finished speaking.

Optionally, in addition to IMU sensor 208, the smart glasses 200 may further include other data sensing components electrically connected to processor 203, such as at least one of: a positioning component, a touch sensor, a temperature sensor, a proximity sensor, a humidity sensor, an electronic compass, a timer, a camera and a pedometer. The positioning component may be, but not limited to, the positioning component based on the GPS (Global Positioning System) or the Beidou satellite. In some embodiments, the camera may be configured to acquire visual data associated with a speaker, a mouth region of the speaker, facial movement of the speaker, lip movement of the speaker, a gesture of the speaker, or another visually detectable feature associated with speech. In some embodiments, when audio detected by the speech pickup device is insufficient, noisy, incomplete, or associated with a confidence value below a threshold, the processor may activate the camera to acquire visual data for use in lip-reading, visual speech recognition, or audio-visual speech interpretation. In some embodiments, the processor may use the visual data alone or in combination with speech data detected by the speech pickup device to improve transcription, translation, or speech disambiguation in a noisy environment.

Furthermore, the smart glasses 200 may further include a frame 209 and a battery 210. The frame 209 may be, for example, a front frame with a lens (e.g., a sunglass lens, a clear lens, or a corrective lens). Preferably, the at least one temple 205 is detachably connected to the front frame 209.

Furthermore, in some embodiments, at least one physical control button is provided on the at least one temple 205 and the frame 209, such as a power button, volume control button(s), translation mode switching button(s), etc.

Optionally, in other embodiments of the present disclosure, the smart glasses 200 may further include a display screen electrically connected to the processor 203, and the display screen is used to display the aforementioned second text or translation transcript(s).

In some embodiments, the battery 210 is used for providing power to the aforementioned electronic components on the smart glasses, such as the speech pickup device 201, the output device 202, the at least one processor 203, the at least one memory 204, the virtual button 206, the wireless communication component 207, the IMU sensor 208 and the Bluetooth component 211, etc.

In some embodiments, the various electronic components of the aforementioned smart glasses are connected through a bus.

It should be noted that the relationship between the components of the aforementioned smart glasses is a substitution relationship or a superposition relationship. That is, all the aforementioned components in this embodiment are installed on the smart glasses, or some of the aforementioned components selectively are installed according to requirements. When the relationship is an alternative relationship, the smart glasses are further provided with at least one of a peripheral connection interface, for example, a PS/2 interface, a serial interface, a parallel interface, an IEEE1394 interface, and a USB (Universal Serial Bus) interface. The function of the replaced component is realized through the peripheral device connected to the connection interface, and the peripheral device such as external speaker, external sensor, etc.

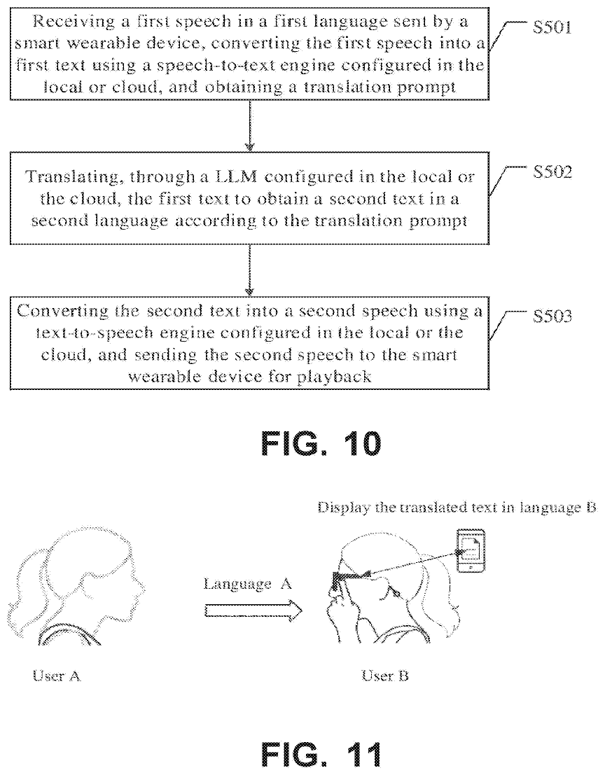

For unspecified details about the smart glasses in this embodiment, please refer to the relevant descriptions in the embodiments of the translation system shown in FIG. 1 to FIG. 7 and the embodiments of the translation method shown in FIG. 10 to FIG. 14, which will not be described again here.

In this and/or some embodiments, by using the LLM(s) through the smart glasses, the intelligent translation based on the smart glasses is realized, thereby improving the practicality, interactivity and intelligence of the smart glasses, and increasing user stickiness in and/or affinity to the product. Moreover, due to the scalability and self-creativity of the LLM, the accuracy of translation can be further improved.

Referring to FIG. 10, a flow diagram of a translation method based on AI according to one embodiment of the present disclosure is illustrated. The method can be applied to the first smart mobile terminal 120 or the second smart mobile terminal 150 in the translation system shown in FIG. 1. As shown in FIG. 10, in some embodiments, the method includes:
S501, receiving a first speech in a first language sent by a smart wearable device, converting the first speech into a first text using a speech-to-text engine configured in the local or cloud, and obtaining a translation prompt;
S502, translating, through a large language model (LLM) configured in the local or the cloud, the first text to obtain a second text in a second language according to the translation prompt, wherein the LLM includes a generative artificial intelligence large language model (GAILLM) or a multimodal large language model (MLLM);
S503, converting the second text into a second speech using a text-to-speech engine configured in the local or the cloud, and sending the second speech to the smart wearable device for playback.

The smart wearable device may include but not limited to, smart safety helmets, smart earphones, smart earrings, smart watches, and smart glasses shown in FIG. 8 and FIG. 9.

Optionally, the first smart mobile terminal 120 generates a translation prompt through a built-in prompt generator; or the first smart mobile terminal 120 generates, through a prompt generator configured in a cloud server, the translation prompt.

Optionally, in other embodiments of the present disclosure, a mobile application is installed on the smart mobile terminal, and the method further includes:

in response to a preset action of a user, sending a translation instruction to the smart wearable device through the mobile application, so that the smart wearable device enters a translation mode in response to the translation instruction, and picks up the first speech in the translation mode.

Optionally, in other embodiments of the present disclosure, a mobile application is installed on the smart mobile terminal, and before receiving the first speech in the first language sent by the smart wearable device, the method further includes:
in response to a user pressing a button on a screen of the smart mobile terminal, sending, through the mobile application, a speech picking up instruction to the smart wearable device to instruct the smart wearable device to pick up the first speech, wherein the button is generated by the mobile application.

The LLM is configured in a model server, and the step of translating, through the LLM configured in the local or cloud, the first text to obtain the second text in the second language according to the translation prompt, in some embodiments, includes:
in response to the user releasing the button, or in response to receiving a notification message sent by the smart wearable device, sending the first text to the translation server through the mobile application, so that the translation server generates the translation prompt, and sends the first text and the translation prompt to the model server, wherein the smart wearable device sends the notification message in response to a user of the smart wearable device releasing a virtual button on a temple of the smart wearable device; and
receiving the second text forwarded by the translation server, wherein the second text is sent to the translation server by the model server, and the model server obtains the second text by using the LLM to translate the first text according to the translation prompt.

Optionally, in other embodiments of the present disclosure, a mobile application is installed on the smart mobile terminal, and the method further includes:
generating, through the mobile application, a translation transcript according to the second text, or the first text and the second text, and displaying the translation transcript on a screen of the smart mobile terminal; and
saving, through the mobile application, the translation transcript on the smart mobile terminal or a storage server.

Optionally, in other embodiments of the present disclosure, the method further includes: in response to an action of a user performed on a sharing button in a user interface (UI) of the mobile application being detected, sharing, through the mobile application, the translation transcript according to a sharing manner indicated by the action.

Optionally, in other embodiments of the present disclosure, a mobile application is installed on the smart mobile terminal, and before sending the second speech to the smart wearable device for playback, the method further includes:

adjusting, through the mobile application, a playback speed of the second speech to a preset playback speed.

Optionally, in other embodiments of the present disclosure, a mobile application is installed on the smart mobile terminal, the LLM is configured in the model server. The smart wearable device performs a speech picking up action, and sends the picked-up speech to the smart mobile terminal in real time via a Bluetooth in a form of data stream, and the method further includes:
setting up the second language, according to a setting action performed by a user through the mobile application;
the step of converting the first speech into the first text using the speech-to-text engine configured in the local or cloud, and obtaining the translation prompt includes:
receiving a speech sent by the smart wearable device, and detecting whether a language of the received speech is the first language using the speech-to-text engine; and
in response to the language being the first language, sending, through the Bluetooth, a starting translation instruction to the smart wearable device to instruct the smart wearable device to enter a translation mode, using the speech-to-text engine to convert the received speech as the first speech into the first text, and generating the translation prompt, wherein the translation prompt includes information of the first language and the second language.

In some embodiments, the method further includes: in response to a silence of a preset duration being detected, sending, through the Bluetooth, a stopping translation instruction to the smart wearable device to instruct the smart wearable device to exit the translation mode and end the speech picking up action.

Optionally, in other embodiments of the present disclosure, the first speech is a speech from a user of the smart wearable device, and the method further includes:
sending the second speech to a target terminal, so that the target terminal sends the second speech to a target smart wearable device for playback.

Optionally, in other embodiments of the present disclosure, a mobile application is installed on the smart mobile terminal, and the method further includes:
generating, through the mobile application, a translation prompt, when the smart wearable device is used as a master smart wearable device (i.e., a host) and is paired with a plurality of slave smart wearable devices (i.e., clients);
translating, through the LLM, the first text to obtain a plurality of third texts according to the generated translation prompt, wherein a language of each of the third texts corresponds to a language spoken by a user of each of the slave smart wearable devices; and
distributing each of the third texts to corresponding slave smart wearable devices, so that the corresponding slave smart wearable devices convert the received third text into a third speech using a text-to-speech engine and play the third speech.

In the aforementioned translation method provided by the present disclosure, the smart wearable device has a plurality of translation modes, and specifically may include: a listening mode, a talking mode, a paired mode and a multi-points mode. The multi-points mode can be applied to application scenarios such as tour guide and conference, and that like.

As an application example, taking the smart glasses and the mobile phone as examples, in scenario A of the listening mode:
A-a, a user wearing smart glasses can use this mode to listen to a foreign language speech of the other party using the smart glasses, and use the smart glasses to translate the foreign language speech into a native language speech and play the native language speech;
A-b, the user can set up the foreign language and the native language for translation through a built-in application (APP) of the smart glasses;
A-c, the user can set up the playback speed of the native language speech;
A-d, the user can activate the translation function through a mobile APP on the mobile phone, to trigger the smart glasses to enter the translation mode.
A-e, the user presses-and-holds a virtual button on the smart glasses, or the user presses-and-holds an on-screen button on the UI of the mobile APP on the screen of the mobile phone, and the microphone of the smart glasses starts to listen to the foreign language speech of the other party;
A-f, the smart glasses send the foreign language speech in audio format to the mobile APP in real time via Bluetooth;
A-g, the mobile APP runs a speech-to-text engine (in cloud or local device), to convert the foreign language speech into a foreign language text;
A-h, at the same time, the mobile APP displays the transcript in foreign language, and the transcript in foreign language can be shared or saved;
A-i, when the virtual button on the smart glasses is released, or when the on-screen button of the mobile APP on the screen of the mobile phone is released, the mobile APP sends the foreign language text to the translation server;
A-j, the translation server sends the foreign language text to a LLM (in the cloud or local) together with a translation prompt (generated at the translation server);
A-k, the LLM translates the foreign language text in text format into a native language text, and sends the native language text back to the translation server;
A-l, the translation server sends the native language text back to the mobile APP in text format;
A-m, the mobile APP converts the native language text into a speech through a text-to-speech engine (in the cloud or local device);
A-n, the mobile APP displays the translated transcript in native language on the screen, and the translated transcript in native language can be shared or saved on the mobile phone;
A-o, the mobile APP sends the translated native language speech with a desired playback speed in audio format back to the smart glasses;
A-p, the smart glasses play the translated native language speech through a speaker.

As an application example, taking the smart glasses and the mobile phone as examples, in scenario B of the listening mode:
B-a, similar to the scenario A, but the user does not need to set up the foreign language, and only needs to set up the native language;
B-b, the speech-to-text engine can automatically detect which foreign language it is.

As an application example, taking the smart glasses and the mobile phone as examples, in scenario C of the listening mode:
C-a, extending to the scenario B, the user does not need to use the virtual button on the smart glasses or the on-screen button on the mobile APP to start or stop listening.
C-b, when the speech-to-text engine detects that the speech is in the foreign language, it will automatically start to translate the picked-up speech and stop the translation after a silence of a duration is detected.

As an application example, taking the smart glasses and the mobile phone as examples, in scenario D of the listening mode:
D-a, similar to the aforementioned scenarios A, B, or C, but without the mobile APP.
D-b, the smart glasses directly send the foreign language speech to the translation server and directly play the native language speech on the smart glasses, which is received by the translation server.

As an application example, taking the smart glasses and the mobile phone as examples, in scenario E of the talking mode:
E-a, a user wearing smart glasses can use this mode to listen to the user's own native language speech using the smart glasses, and use the smart glasses to play the translated foreign language speech through the attached front speaker;
E-b, the user can set up the native language and the foreign language through a built-in APP of the smart glasses;
E-c, the user can set up the playback speed of the foreign language speech;
E-d, the user activates the translation function through a mobile APP on the mobile phone;
E-e, the user presses-and-holds a virtual button on the smart glasses, or the user presses-and-holds an on-screen button on the UI of the mobile APP on the screen of the mobile phone, and the microphone of the smart glasses starts to listen to the native language speech of the user;
E-f, the smart glasses send the native language speech in audio format to the mobile APP in real time via Bluetooth;
E-g, the mobile APP runs a speech-to-text engine (in cloud or local device), to convert the native language speech into a native language text;
E-h, at the same time, the mobile APP displays a transcript in native language, and the transcript in native language can be shared or saved;
E-i, when the virtual button on the smart glasses is released, or when the on-screen button on the mobile APP is released, the mobile APP sends the native language text in form of text to the translation server;
E-j, the translation server sends the native language text to a LLM (in the cloud or local) together with a translation prompt (generated at the translation server);
E-k, the LLM translates the foreign language text in text format into a foreign language text in text format and sends the foreign language text in text format back to the translation server;
E-l, the translation server sends the foreign language text in text format back to the mobile APP;
E-m, the mobile APP converts the foreign language text into a corresponding foreign language speech through a text-to-speech engine (in the cloud or local device);
E-n, the mobile APP displays a transcript in foreign language, and the transcript in foreign language can be shared or saved;
E-o, the mobile APP sends the foreign language speech with a desired playback speed in audio format back to the smart glasses;
E-p, the smart glasses play the foreign language speech through the front speaker so that the other party can listen.

As an application example, taking the smart glasses and the mobile phone as examples, in scenario F of the talking mode:
F-a, similar to the scenario D, the foreign language speech is played through the mobile APP on the mobile phone, rather than through the front speaker on the smart glasses or the external speakers paired with the smart glasses.

As an application example, taking the smart glasses and the mobile phone as examples, in scenario G of the talking mode:
G-a, similar to the scenario E or scenario F, but the user does not need to release the virtual button on the glasses or the on-screen button on the mobile APP to indicate the end of the speech;
G-b, the listening can be started if the user presses and immediately releases the virtual button on the smart glasses or the on-screen button on the mobile APP;
G-c, the smart glasses can automatically detect whether the user speech has ended through the VAD algorithm or/and IMU signals.

As an application example, taking the smart glasses and the mobile phone as examples, in scenario H of the talking mode, the following actions further can be performed:
H-a, similar to the scenario G, the user does not need to use the on-screen button on the mobile APP or the virtual button on the glasses to start listening;
H-b, when the speech-to-text engine detects that the picked-up speech is in the native language, it will automatically start to translate the picked-up speech.

As an application example, taking the smart glasses and the mobile phone as examples, in scenario I of the talking mode:
I-a, similar to the scenarios E, G, or H, but without the mobile APP;
I-b, the smart glasses directly send the native language speech to the translation server and play the translated foreign language speech directly through the front speaker on the smart glasses or the external speaker paired with the smart glasses.

As an application example, taking the smart glasses and the mobile phone as examples, in scenario J of the paired mode:
J-a, users A and B wear smart glasses A and B respectively, and speak languages A and B respectively; the smart glasses A and B correspond to mobile phones A and B respectively, and these smart glasses are paired for translation mode;
J-b, the user A presses-and-holds a virtual button on the smart glasses A, or presses-and-holds an on-screen button on the mobile application A, and the microphone of the smart glasses A starts to listen to a speech in language A of the user A;
J-c, the smart glasses A send the speech in language A in audio format in real time to the mobile phone A via Bluetooth;
J-d, the mobile application A use a speech-to-text engine (in cloud or local device) to convert the speech in language A into the first text in language A;
J-e, when the user A releases the virtual button on the smart glasses A, or the on-screen button on the mobile application A, the mobile application A sends the first text in language A form of text to the translation server;
J-f, the translation server sends the first text in language A together with a translation prompt to LLM(s) (in the cloud or local) in form of text;
J-g, the LLM(s) translates the first text in language A in text format into the second text in language B in text format, and sends the second text in language B back to the translation server;
J-h, the translation server sends the second text in language B to the mobile application B in the mobile phone B in text format;
J-i, the mobile application B converts the second text in language B into a speech in language B through a text-to-speech engine (in cloud or local device);
J-j, the mobile application B sends the speech in language B to the smart glasses B in audio format;
J-k, the smart glasses B play the speech in language B through the speaker, so that the user B can listen;
J-l, transcripts of languages A and B (that is, the original transcript of the user A, and the translated transcript of the user A) are displayed on the mobile applications A and B, and can be shared and saved;
J-m, conversely, when the user B wants to communicate with the user A, the user B only needs to repeat the steps from J-b to J-I, the speech of the user B is translated into the speech in language A, and the speech in language A is played on the smart glasses A of the user A.

As an application example, taking the smart glasses and the mobile phone as examples, in scenario K of the multi-points mode:
K-a, users A, B, C and D wear smart glasses A, B, C and D respectively, and speak languages A, B, C and D respectively; the smart glasses A, B, C and D are paired for translation mode, the smart glasses A, B, C and D perform data interaction with mobile phones A, B, C and D via Bluetooth respectively, and mobile applications A, B, C and D are installed on the mobile phones A, B, C and D respectively;
K-b, the user A presses-and-holds the right temple of the smart glasses A and speaks, a microphone of the smart glasses A picks up a speech A in language A of the user A, and sends the speech A to the translation server in the form of text through the mobile application A; the translation server translates the text in language A into texts in languages B, C and D, and sends the translated texts to the corresponding smart glasses B, C and D respectively; the smart glasses B, C and D respectively convert the received text into corresponding speech through the speech-to-text engine, and then play the converted speech to their respective users through their respective speakers.
K-c, when the user B wants to communicate with the user A, the user B presses-and-holds the right temple of the smart glasses B and speaks, the microphone of smart glasses B picks up a speech of the user B and converts the picked-up speech in language B into a text in language B through the speech-to-text engine, and the text in language B is sent to the translation server by the smart glasses B; the translation server translates the text in language B into a text in language A, and then sends the text in language A to smart glasses A; the smart glasses A use a text-to-speech engine to convert the text in language A into a speech in language A, and then play the speech in language A through the speaker of smart glasses A.
K-d, the users C and D communicate with the user A in different languages through the steps K-c.

In order to further illustrate the aforementioned four translation modes, the following will be described with reference to FIG. 11 to FIG. 14.

As shown in FIG. 11, in the listening mode, the user A does not wear the smart glasses, and the user B wears the smart glasses. The smart glasses worn on the user B establish a data connection with a mobile APP on a mobile phone of the user B via Bluetooth. The user B can set up the language A spoken by the user A and the language B spoken by the user B through the mobile APP and switch the current translation mode to the listening mode. In the listening mode, the language A spoken by the user A is the first language (i.e., the source language), and the language B spoken by the user B is the second language (i.e., the target language).

When the user B presses-and-holds a virtual button on the right temple of smart glasses worn on the user B, the user A starts speaking, and the smart glasses pick up a speech of user A through the microphone and send the picked-up speech in language A of the user A to the mobile APP. When the user B releases the virtual button, the mobile APP uses the LLM to translate the received speech into a speech in language B and sends the speech in language B to the smart glasses, so that the smart glasses play the speech in language B for the user B through the built-in speaker.

At the same time, the mobile APP displays the original text in language A corresponding to the speech of user A and the translated text in language B on the screen of the mobile phone of user B.

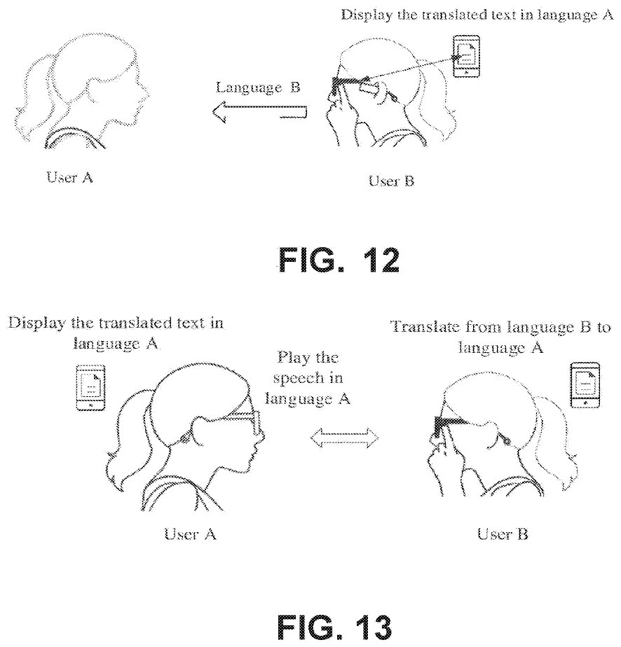

As shown in FIG. 12, in the talking mode, the user A does not wear the smart glasses, and the user B wears the smart glasses. The smart glasses worn on the user B establish a data connection with a mobile APP on a mobile phone of the user B via Bluetooth. The user B can set up the language A spoken by the user A and the language B spoken by the user B through the mobile APP and switch the current translation mode to the talking mode. In the talking mode, the language B spoken by the user B is the first language (i.e., the source language), and the language A spoken by the user A is the second language (i.e., the target language).

When the user B presses-and-holds a virtual button on the right temple of smart glasses worn on the user B, the user B starts speaking, and the smart glasses pick up a speech of user B through the microphone and send the picked-up speech in language B of user B to the mobile APP. When the user B releases the virtual button, the mobile APP uses the LLM to translate the received speech into a speech in language A and sends the speech in language A to the smart glasses, so that the smart glasses play the speech in language A for the user A through the front speaker.

At the same time, the mobile APP displays the original text in language B corresponding to the speech of user B and the translated text in language A on the screen of the mobile phone of user B.

Furthermore, the listening mode shown in FIG. 11 may be combined with the talking mode shown in FIG. 12. Specifically, the user A does not wear the smart glasses, and the user B wears the smart glasses. The smart glasses worn on the user B establish the data connection with the mobile APP on the mobile phone of the user B via Bluetooth.

On the one hand, when the user B presses-and-holds the virtual button on the right temple of smart glasses worn on the user B, the smart glasses enter the listening mode, and the smart glasses pick up the speech of user A through the microphone and send the picked-up speech in language A of user A to the mobile APP.

When the user B releases the virtual button, the smart glasses translate, through the mobile APP, the speech in language A into the speech in language B using the LLM and play the speech in language B for the user B through the built-in speaker. At the same time, the mobile APP displays the original text in language A corresponding to the speech in language A and the translated text in language B on the screen of the mobile phone of user B.

On the other hand, when the smart glasses detect, through the VAD algorithm and/or the IMU sensor on the smart glasses, that the user B starts speaking, the smart glasses switch the current translation mode from the listening mode to the talking mode, pick up the speech of the user B through the microphone, and send the picked-up speech in language B of the user B to the mobile APP.

When the smart glasses detect, through the VAD algorithm and/or the IMU sensor on the smart glasses, that the user B stops speaking, the smart glasses translate, through the mobile APP, the speech in language B into the speech in language A using the LLM, and play the speech in language A for the user A through the front speaker of the smart glasses, or the external speaker, or the mobile phone. At the same time, the mobile APP displays the original text in language B corresponding to the speech in language B and the translated text in language A on the screen of the mobile phone of user B.

As shown in FIG. 13, in the paired mode, the user A wears the smart glasses A, and the user B wears the smart glasses B. The smart glasses A worn on the user A establish the data connection with the mobile APP on the mobile phone A of the user A via Bluetooth. The smart glasses B worn on the user B establish the data connection with the mobile APP on the mobile phone B of the user B via Bluetooth. The smart glasses A and the smart glasses B are paired through the mobile phone A and the mobile phone B.

Through the mobile APP on the mobile phone A, the user A can set up the language A spoken by the user A and the language B spoken by the user B and switch the current translation mode to the paired mode. In the paired mode, in the mobile phone A, the language A spoken by the user A is the first language (i.e., the source language), and the language B spoken by the user B is the second language (i.e., the target language).

Through the mobile APP on the mobile phone B, the user B can set up the language B spoken by the user B and the language A spoken by the user A and switch the current translation mode to the paired mode. In the paired mode, in the mobile phone B, the language B spoken by the user B is the first language (i.e., the source language), and the language A spoken by the user A is the second language (i.e., the target language).

When the user B presses-and-holds the virtual button on the right temple of smart glasses B worn on the user B, the user B starts speaking, and the smart glasses B pick up the speech of user B through the microphone and send the picked-up speech in language B to the mobile APP on the mobile phone B. When the user B releases the virtual button, the mobile APP on the mobile phone B translates the speech in language B into the text in language A using the LLM, and sends the text in language A to the mobile APP on the mobile phone A. The mobile APP on the mobile phone A converts the text in language A into the corresponding speech in language A and sends the speech in language A to the smart glasses A for playback.

When the user A presses-and-holds the virtual button on the right temple of smart glasses A worn on the user A, the smart glasses A and the mobile phone A translate the picked-up the speech in language A of user A into the text in language B and send the text in language B to the mobile APP on mobile phone B in the similar manner to the user B. The mobile APP on the mobile phone B converts the text in language B into the corresponding speech in language B and sends the speech in language B to the smart glasses B for playback.

Furthermore, the mobile APP on the mobile phone A displays the original text and the translated text processed by itself on the screen of mobile phone A. The mobile APP on the mobile phone B displays the original text and the translated text processed by itself on the screen of mobile phone B.

Furthermore, the mobile phones A and B can further display the original text and the translated text processed by the other party on their respective screens through sharing.

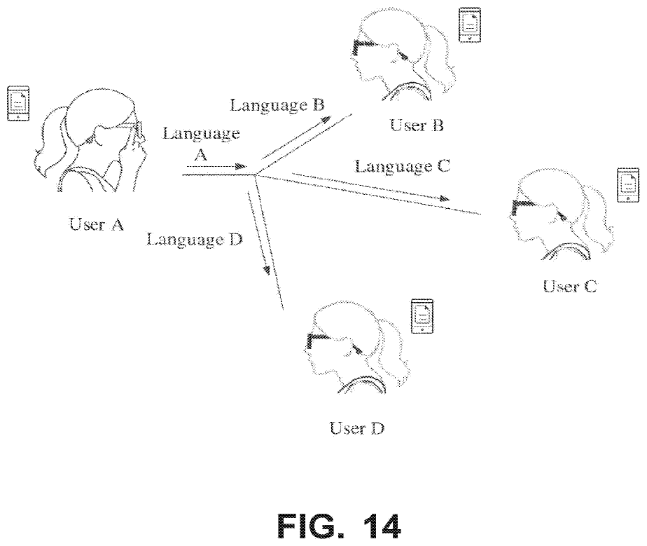

As shown in FIG. 14, in the multi-points mode of tour guide, the users A, B, C and D wear smart glasses A, B, C and D, respectively. The user A is a tour guide, and the smart glasses A worn on the user A are host (i.e., the master smart glasses). The users B, C, and D are tourists, and the smart glasses B, C, and D worn on the users B, C, and D are clients (i.e., slave smart glasses). The smart glasses A, B, C and D establish data connections with mobile phones A, B, C and D, respectively.

When the user A presses the virtual button on the smart glasses A, the smart glasses A pick up the speech in language A of the user A, and then use the translation method in the aforementioned embodiments to translate, through the data interaction with the mobile phone A, the speech in language A into the speech in language B, the speech in language C and the speech in language D, and send the speech in language B, the speech in language C and the speech in language D to the smart glasses B, C and D respectively.

When the user B presses the virtual button on the smart glasses B, the smart glasses B pick up the speech in language B of the user B, and then use the translation method in the aforementioned embodiments to translate, through the data interaction with the mobile phone B, the speech in language B into the speech in language A, and send the speech in language A to the smart glasses A.

Furthermore, the terminal responsible for translation can further generate translation transcripts based on the original text and the translated text and distribute the translation transcripts to each smart glasses and/or each mobile phone for sharing.

For unspecified details about the translation method in this embodiment, please refer to the relevant descriptions in the embodiments shown in FIG. 1 to FIG. 9, which will not be described again here.

In this and/or some embodiments, by using the smart mobile terminal combined with the LLM, the intelligent translation based on the smart glasses is realized, thereby improving the practicality, interactivity and intelligence of the smart glasses, and increasing the user stickiness in and/or affinity to the product. Moreover, due to the scalability and self-creativity of the LLM, the accuracy of translation can be further improved.

The present disclosure, in some embodiments, further provides a non-transitory computer-readable storage medium, which can be set in the smart glasses or smart wearable device or smart mobile terminal in the above-mentioned embodiments, and may be the memory 204 in the embodiment shown in FIG. 8. The computer-readable storage medium stores one or more computer programs. When the one or more programs are executed by the processor, all or part of the translation method based on AI, in the above-mentioned embodiment(s) is performed. Further, the computer-readable storage medium may also be a USB flash drive, a mobile hard disk, a read-only memory (ROM), a Random Access Memory (RAM), a disk, or a CD-ROM, or any medium capable of storing program code.

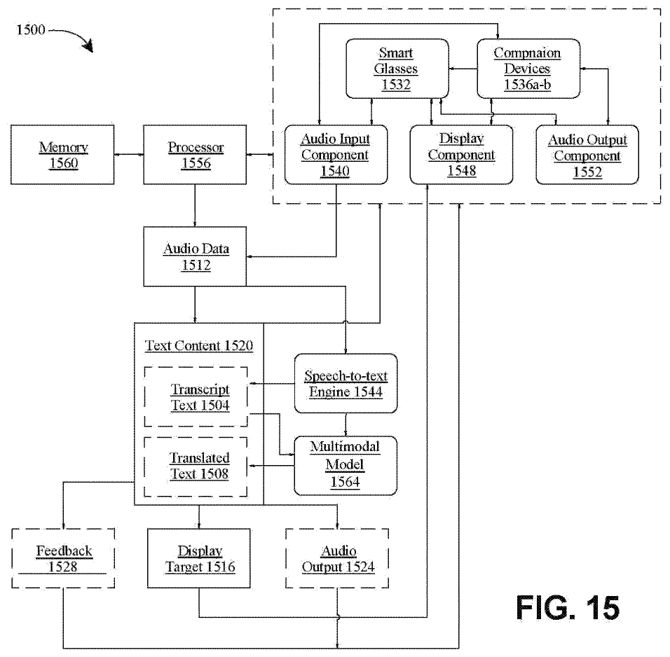

Referring now to FIG. 15, a block diagram of an exemplary apparatus for audio processing is illustrated. In some embodiments, apparatus 1500 may include one or more components described with respect to translation system 100, first smart glasses 110, first smart mobile terminal 120, cloud server 130, translation server 131, model server 132, smart glasses 200, smart glasses 401, smart mobile terminal 402, text-to-speech server 403, speech-to-text server 404, translation server 405, and/or model server 406 described with respect to FIGS. 1-14. In some embodiments, apparatus 1500 may extend the translation processes described with respect to FIGS. 1-14 by generating, displaying, routing, and/or playing back transcript text 1504, translated text 1508, and/or other text content 1520 associated with a conversation.

With continued reference to FIG. 15, for the purposes of this disclosure, “conversation” is spoken communication involving one or more speakers during a communication. In some cases, the communication may include session, listening session, meeting, interaction, presentation, call, group discussion, guided work session, travel interaction, customer-service interaction, enterprise interaction, vehicle interaction, aircraft interaction, or other spoken exchange. In some embodiments, conversation may include speech from a user of apparatus 1500, speech from another participant, speech from multiple participants, speech from a remote participant, speech detected in an enterprise space, or speech detected in a vehicle or aircraft environment. As a non-limiting example, conversation may include a first participant speaking English and a second participant speaking Japanese, where apparatus 1500 may generate transcript text 1504 corresponding to the English speech and translated text 1508 corresponding to Japanese text for display.

With continued reference to FIG. 15, for the purposes of this disclosure, “audio processing” is computational processing of audio data to produce an output. In some embodiments, audio processing may include detecting audio data 1512, converting audio data 1512 into transcript text 1504, translating transcript text 1504 into translated text 1508, determining display target 1516, displaying text content 1520, generating audio output 1524, generating conversation feedback 1528, routing transcript text 1504 and translated text 1508 to different output devices, and/or coordinating operation between smart glasses 1532 and companion device 1536a-b. Advantageously, audio processing may improve computational efficiency, speed, and accuracy by distributing processing among local processors, wearable processors, companion-device processors, enterprise edge processors, and/or cloud processors.

With continued reference to FIG. 15, for the purposes of this disclosure, “audio input component” is a component configured to detect sound, or audio signal. In some embodiments, audio input component 1540 may include a microphone, directional microphone, omnidirectional microphone, microphone array, beamforming microphone array, earbud microphone, smart-glasses microphone, smartphone microphone, conference-room microphone, factory-floor microphone, vehicle microphone, aircraft microphone, vibration sensor, inertial measurement unit-assisted voice pickup device, or another acoustic sensing component. In some embodiments, audio input component 1540 may be consistent with the speech pickup device described with respect to smart glasses 200 and/or the speech pickup device 201 described with respect to FIGS. 8 and 9.

With continued reference to FIG. 15, in some embodiments, audio input component 1540 may be configured to detect audio data 1512 corresponding to conversation by sampling an analog acoustic waveform, converting the analog acoustic waveform into digital audio samples, and applying one or more preprocessing operations to the digital audio samples. For example, and without limitation, preprocessing operations may include gain normalization, echo cancellation, wind-noise suppression, background-noise suppression, voice activity detection, beamforming, dereverberation, speaker diarization pre-segmentation, wake-word detection, packetization, compression, encryption, or buffering. These operations may improve performance and accuracy of downstream speech-to-text engine 1544 by minimizing irrelevant noise and maximizing the signal-to-noise ratio of speech portions of audio data 1512.

With continued reference to FIG. 15, for the purposes of this disclosure, “audio data” is digital or analog data representing sound, or audio signal. In some embodiments, audio data 1512 may include raw waveform data, compressed audio data, encoded audio frames, streamed audio packets, buffered audio segments, microphone-array channel data, beamformed audio data, enhanced audio data, or temporally segmented speech data. In some embodiments, audio data 1512 may correspond to the first speech described with respect to FIGS. 1-14, and audio data 1512 may be converted into transcript text 1504 in a manner consistent with conversion of the first speech into first text described with respect to the original translation architecture.

With continued reference to FIG. 15, for the purposes of this disclosure, “display component” is a component configured to visually or otherwise output data to a user. In some embodiments, display component 1548 may include an audio output component 1552. In some embodiments, display component 1548 may include a visual output component. For the purposes of this disclosure, “visual output component” is a component configured to visually present data to a user. In some embodiments, visual output component may include a display screen, an on-lens display, a micro-display, a Micro-OLED display, a micro-LED display, a liquid-crystal-on-silicon display, a waveguide display, a heads-up display, a projection display, a retinal projection display, a light-emitting diode display, a transparent display, a near-eye display, a display module, a smart-glasses display, a smartphone display, a smartwatch display, a tablet display, a laptop display, a vehicle display, an aircraft display, an enterprise dashboard display, or another component configured to output visible information. In some embodiments, visual output component may be configured to display at least a portion of text content 1520, transcript text 1504, translated text 1508, conversation feedback 1528, display target 1516 indicators, speaker labels, timestamps, confidence indicators, user-interface elements, or other visual data associated with audio processing. In some embodiments, display component 1548 may be consistent with the display screen described with respect to smart glasses 200 and/or the display screens of smart mobile terminals described with respect to FIGS. 1-14.

With continued reference to FIG. 15, in some embodiments, display component 1548 may be configured to display data by receiving display data, rendering instructions, graphical interface instructions, formatted text, caption text, translation text, transcript panes, subtitle regions, speaker labels, highlighting, confidence indicators, feedback indicators, scrolling regions, or layout metadata. In some embodiments, display component 1548 may display text content 1520 in a display region selected to minimize obstruction of a field of view while maximizing readability. As a non-limiting example, display component 1548 on smart glasses 1532 may present translated text 1508 in a lower-right region of a lens, while transcript text 1504 may be presented on companion device 1536a-b for a supervisor or another participant. In some embodiments, display component 1548 may be removably coupled to smart glasses 1532.

With continued reference to FIG. 15, in some embodiments, processor 1556 may be consistent with processor 203 described with respect to smart glasses 200 and may include a CPU, DSP, MCU, neural accelerator, or distributed processing resources located in apparatus 1500, smart glasses 1532, companion device 1536a-b, enterprise edge equipment, or cloud resources. In some embodiments, processor 1556 may improve speed and efficiency by assigning audio preprocessing to a DSP, speech-to-text processing to an NPU, and language-model inference to a local or remote accelerator.

With continued reference to FIG. 15, in some embodiments, memory 1560 may be consistent with memory 204 described with respect to smart glasses 200. In some embodiments, memory 1560 may store instructions configuring processor 1556 to perform the operations of apparatus 1500, store audio data 1512 temporarily, store transcript text 1504, store translated text 1508, store text content 1520, store language packages, store display layouts, store user preferences, store communication session data, and/or store model parameters for speech-to-text engine 1544 or multimodal model including but not limited to large language model.

With continued reference to FIG. 15, in some embodiments, memory 1560 may be communicatively connected to processor 1556 through a bus, internal communication line, memory controller, wireless link, wired link, system-on-chip interconnect, peripheral interface, or distributed computing network. In some embodiments, memory 1560 may contain instructions configuring processor 1556 to receive audio data 1512 from audio input component 1540. As a non-limiting example, memory 1560 may store an audio-receiving routine that buffers streaming audio data 1512 in rolling time windows, tags each window with timing information, and passes the buffered audio data 1512 to speech-to-text engine 1544 for conversion into transcript text 1504.

With continued reference to FIG. 15, in some embodiments, processor 1556 may receive audio data 1512 from audio input component 1540 by receiving streamed frames, buffered audio segments, packetized audio, locally sampled microphone data, or wirelessly received microphone data. In some embodiments, processor 1556 may receive audio data 1512 directly from a microphone arranged on smart glasses 1532, from a microphone arranged on companion device 1536a-b, from an enterprise conference-room hub, or from another device participating in conversation. This configuration advantageously improves flexibility and accuracy because apparatus 1500 may select a higher-quality audio source when one device has a weak microphone signal, high noise level, or poor orientation relative to a speaker.

With continued reference to FIG. 15, for the purposes of this disclosure, “text content” is textual data processed based on audio data. In some embodiments, text content 1520 may include transcript text 1504, translated text 1508, a translation transcript, captions, speaker-labeled captions, source-language text, target-language text, summary text, feedback text, confidence text, correction text, punctuation, timestamps, speaker identifiers, display formatting, or combinations thereof. In some embodiments, summary text may include a summary of transcript text 1504, a summary of translated text 1508, a summary of a translation transcript, a summary of audio data 1512, a summary of feedback 1528, a meeting summary, an action-item summary, a question-and-answer summary, a speaker-specific summary, or a response summary. In some embodiments, feedback text may include feedback 1528 generated based on transcript text 1504, translated text 1508, audio data 1512, a summary of translated text 1508, a summary of transcript text 1504, a user response, a reply suggestion, a suggested clarification, a suggested follow-up question, a suggested answer, a suggested translated response, a tone-adjusted response, or a translation-quality indication. In some embodiments, text content 1520 may be generated from conversation audio, presentation audio, meeting audio, call audio, lecture audio, media audio, announcement audio, environmental audio, vehicle audio, aircraft audio, factory-floor audio, conference-room audio, or another audio source. In some embodiments, text content 1520 may correspond to translation transcripts described with respect to FIGS. 1-14, including transcripts generated according to first text and second text.

With continued reference to FIG. 15, in some embodiments, processor 1556 may generate text content 1520 as a function of audio data 1512 by executing a pipeline in which audio data 1512 is passed to speech-to-text engine 1544, speech-to-text engine 1544 outputs transcript text 1504, transcript text 1504 is passed to multimodal model including but not limited to LLM with a translation prompt, multimodal model including but not limited to LLM outputs translated text 1508, and processor 1556 combines transcript text 1504 and translated text 1508 into text content 1520. As a non-limiting example, audio data 1512 containing the spoken phrase “where is the entrance” may be converted into transcript text 1504 stating “where is the entrance,” and transcript text 1504 may be translated into translated text 1508 stating the same meaning in Korean, Japanese, Spanish, or another target language.

With continued reference to FIG. 15, for the purposes of this disclosure, “transcript text” is text generated from audio data. In some embodiments, transcript text 1504 may be consistent with the first text described with respect to FIGS. 1-14. In some embodiments, transcript text 1504 may include recognized words, punctuation, capitalization, speaker labels, timestamps, confidence indicators, diarization markers, non-speech event labels, language identifiers, utterance boundaries, or corrected text. In some embodiments, transcript text 1504 may be generated before translation so that apparatus 1500 provides a transcription capability that advances beyond audio-only translation playback and improves usability, accessibility, and real-time review.

With continued reference to FIG. 15, for the purposes of this disclosure, “speech-to-text engine” is a computational engine configured to convert audio data into transcript text. In some embodiments, speech-to-text engine 1544 may include an automatic speech recognition model, acoustic model, pronunciation model, language model, end-to-end neural speech recognition model, transformer-based speech model, recurrent neural network model, convolutional neural network model, connectionist temporal classification model, attention encoder-decoder model, transducer model, self-supervised acoustic encoder, diarization model, punctuation model, capitalization model, or language-detection model. In some embodiments, speech-to-text engine 1544 may be configured in apparatus 1500, smart glasses 1532, companion device 1536a-b, an enterprise edge device, a local device, or cloud.

With continued reference to FIG. 15, in some embodiments, speech-to-text engine 1544 may be trained using training data comprising paired speech audio and corresponding reference transcripts. For example, and without limitation, training data for speech-to-text engine 1544 may be obtained from user-consented recordings of conversations, customer-support interactions, meeting recordings, multilingual speech corpora, device-captured audio from smart glasses 1532, microphone-array recordings from companion device 1536a-b, synthetic speech generated from text-to-speech systems, enterprise-approved meeting transcripts, and manually corrected transcripts. In some embodiments, each training example may include audio data 1512 as model input and transcript text 1504 as a training label, and speech-to-text engine 1544 may learn to predict transcript text 1504 by minimizing recognition errors between predicted text and labeled reference text.

With continued reference to FIG. 15, in some embodiments, speech-to-text engine 1544 may include a frontend feature extractor that converts audio data 1512 into acoustic features, an encoder that transforms acoustic features into latent speech representations, a decoder that generates word piece or character sequences, and a postprocessor that inserts punctuation, capitalization, and speaker labels. For example, and without limitation, the frontend feature extractor may generate mel-frequency features from audio data 1512, the encoder may use transformer attention layers to model long-range speech context, the decoder may output transcript text 1504, and the postprocessor may generate final text content 1520 by adding utterance boundaries and punctuation. This technical architecture may improve accuracy and speed by allowing streaming transcription of conversation.

With continued reference to FIG. 15, in some embodiments, transcript text 1504 may be generated in real time, near real time, or after a buffered portion of conversation has been captured. In some embodiments, processor 1556 may send partial transcript text 1504 to display component 1548 before an utterance is complete, update transcript text 1504 as additional audio data 1512 is received and replace lower-confidence text with higher-confidence text after speech-to-text engine 1544 processes a larger context window. This may improve perceived speed and user experience while maintaining final transcription accuracy.

With continued reference to FIG. 15, for the purposes of this disclosure, “source language” is the language represented by transcript text before translation. For the purposes of this disclosure, “target language” is the language represented by translated text after translation. In some embodiments, source language and target language may be selected by a user, inferred from audio data 1512, inferred from transcript text 1504, determined from a profile associated with smart glasses 1532, determined from a profile associated with companion device 1536a-b, determined from conversation context, or provided by a translation prompt. In some embodiments, source language and target language may be consistent with the first language and second language described with respect to FIGS. 1-14.

With continued reference to FIG. 15, for the purposes of this disclosure, “multimodal model” is a machine-learning model configured to receive, process, or generate data of two or more data modalities. In some embodiments, multimodal model 1564 may include LLM, a multimodal large language model, a vision-language model, an audio-language model, a speech-language model, an audio-text model, an image-text model, a video-text model, or another model configured to process a combination of audio data 1512, transcript text 1504, translated text 1508, image data, video data, sensor data, display data, user input data, or conversation context data. In some embodiments, multimodal model 1564 may receive audio data 1512 and text data as inputs and generate transcript text 1504, translated text 1508, text content 1520, feedback 1528, audio output 1524, display target 1516, or routing instructions as outputs. As a non-limiting example, multimodal model 1564 may receive audio data 1512 and prior transcript text 1504 as inputs and output translated text 1508 in target language. As another non-limiting example, multimodal model 1564 may receive transcript text 1504, translated text 1508, and device-context data as inputs and output feedback 1528 comprising a suggested reply or suggested clarification.

With continued reference to FIG. 15, for the purposes of this disclosure, “large language model” is a large language model configured to process natural language text. In some embodiments, LLM may include a generative artificial intelligence large language model, multimodal large language model, transformer model, encoder-decoder translation model, decoder-only model, multilingual model, instruction-tuned model, enterprise-managed language model, local language model, cloud-hosted language model, edge-hosted model, or compressed wearable-compatible model. In some embodiments, LLM may be consistent with the LLM described with respect to cloud server 130, model server 132, model server 406, or smart mobile terminal 402 of FIGS. 1-14.

With continued reference to FIG. 15, in some embodiments, multimodal model 1564 and/or LLM may be trained using training data comprising paired source-language text and target-language text, multilingual sentence pairs, conversational translation examples, domain-specific glossary examples, user-corrected translations, enterprise-approved translation memories, synthetic parallel text, back-translated text, and context-rich conversation samples. For example, and without limitation, a training example for multimodal model 1564 and/or LLM may include transcript text 1504 in source language as a model input and translated text 1508 in target language as a training label. In some embodiments, training data for LLM may originate from public multilingual corpora, licensed translation corpora, user-consented conversation transcripts, enterprise translation databases, corrected outputs from human translators, and generated examples reviewed by quality-control processes.

With continued reference to FIG. 15, in some embodiments, multimodal model 1564 and/or LLM may receive transcript text 1504, source language, target language, conversation context, speaker labels, prior utterances, domain information, and user preferences as inputs, and multimodal model 1564 and/or LLM may output translated text 1508. For example, and without limitation, speech-to-text engine 1544 may output transcript text 1504 stating “the line is down near station three,” and multimodal model 1564 and/or LLM may use enterprise context indicating a factory-floor setting to output translated text 1508 preserving the technical meaning of “line” as a production line rather than a queue. This technical interaction between speech-to-text engine 1544 and multimodal model 1564 and/or LLM may improve translation accuracy by reducing ambiguity in conversation.

With continued reference to FIG. 15, for the purposes of this disclosure, “translated text” is text generated by translating transcript text from a source language into a target language. In some embodiments, translated text 1508 may be consistent with the second text described with respect to FIGS. 1-14. In some embodiments, translated text 1508 may include target-language words, punctuation, speaker labels, timestamps, confidence indicators, alternate translation candidates, glossary substitutions, localization adjustments, or user-selected formality level. In some embodiments, translated text 1508 may be generated for display as text content 1520, for conversion into audio output 1524, for storage in memory 1560, or for routing to companion device 1536a-b.

With continued reference to FIG. 15, in some embodiments, translating transcript text 1504 using multimodal model 1564 and/or LLM may include obtaining or generating a translation prompt. In some embodiments, the translation prompt may include identification information of source language, identification information of target language, style instructions, domain instructions, speaker-role instructions, display-length instructions, privacy instructions, and/or glossary instructions. For example, and without limitation, processor 1556 may generate a translation prompt instructing multimodal model 1564 and/or LLM to translate transcript text 1504 from German to English, preserve technical nouns associated with manufacturing equipment, and shorten translated text 1508 to fit a display region within display component 1548.

With continued reference to FIG. 15, in some embodiments, processor 1556 may determine whether to translate all transcript text 1504 or only a portion of transcript text 1504. In some embodiments, processor 1556 may translate a selected utterance, a speaker-specific portion, a non-native-language portion, a portion associated with a threshold confidence score, or a portion occurring during a translation mode. As a non-limiting example, processor 1556 may display transcript text 1504 for all speakers but translate only speech from another participant whose source language differs from a preferred language associated with smart glasses 1532.

With continued reference to FIG. 15, for the purposes of this disclosure, “display target” is a selected output destination for displaying text content. In some embodiments, display target 1516 may include display component 1548, a region within display component 1548, a device on which text content 1520 is displayed, a lens region, a heads-up display region, a companion-device display, a smart-glasses display, a smartphone screen, a smartwatch screen, an enterprise dashboard, or another display location. In some embodiments, display target 1516 may support the display-based translation and transcription concepts described for FIG. 15 and may extend transcript display functionality described with respect to FIGS. 1-14.

With continued reference to FIG. 15, in some embodiments, processor 1556 may determine display target 1516 for at least a portion of text content 1520 by analyzing user settings, display availability, device capability, field-of-view constraints, text length, speaker identity, source language, target language, privacy setting, network availability, latency, power state, and/or context of conversation. As a non-limiting example, apparatus 1500 may determine that translated text 1508 is displayed on smart glasses 1532 when the user is walking, while a full transcript text 1504 is displayed on companion device 1536a-b when a larger screen is available. This may improve readability and reduce computational and visual clutter.

With continued reference to FIG. 15, in some embodiments, processor 1556 may use a display-target selection model to determine display target 1516. The display-target selection model may include a rules-based model, machine-learning classifier, reinforcement-learning policy, ranking model, decision tree, gradient-boosted model, neural network, or hybrid model. In some embodiments, training data for the display-target selection model may include historical display events, user selections of display target 1516, device capability logs, display-size information, eye-gaze information, text-length information, latency measurements, readability feedback, correction events, and user satisfaction labels. For example, and without limitation, the model input may include text content 1520 length, device type, user activity, and available display area, and the training label may indicate the display target 1516 selected by the user or determined to produce faster reading speed.

With continued reference to FIG. 15, in some embodiments, determining display target 1516 may comprise determining a display region within display component 1548. In some embodiments, the display region may include an upper region, lower region, left region, right region, central region, peripheral region, floating caption region, subtitle region, notification region, speaker-labeled region, or region positioned relative to a field of view. As a non-limiting example, translated text 1508 may be displayed in a lower region of an on-lens display so that the user can view translated text 1508 without obscuring a face of another participant in conversation.

With continued reference to FIG. 15, in some embodiments, determining display target 1516 may comprise determining a device on which at least a portion of text content 1520 is to be displayed. In some embodiments, the device may include smart glasses 1532, companion device 1536a-b, a smartphone, a smartwatch, a wearable display, a smart terminal, a conference-room display, an enterprise display, a vehicle display, or an aircraft display. As a non-limiting example, processor 1556 may determine that transcript text 1504 is displayed on companion device 1536a-b while translated text 1508 is displayed on smart glasses 1532 because smart glasses 1532 provide immediate in-field translation and companion device 1536a-b provides a larger transcript history.

With continued reference to FIG. 15, in some embodiments, processor 1556 may cause at least a portion of text content 1520 to be displayed by display component 1548 at display target 1516 by generating display data corresponding to text content 1520, formatting text content 1520 according to display target 1516, and transmitting or rendering the display data. In some embodiments, formatting may include line breaking, font scaling, contrast adjustment, scrolling, highlighting, truncation, summarization, text wrapping, subtitle timing, speaker-color association, text alignment, or latency-optimized incremental rendering. This may improve speed and performance because text content 1520 can be displayed as soon as a reliable portion of transcript text 1504 or translated text 1508 is generated.

With continued reference to FIG. 15, in some embodiments, display component 1548 may display transcript text 1504, translated text 1508, or both transcript text 1504 and translated text 1508. In some embodiments, display component 1548 may display transcript text 1504 in source language in one region and translated text 1508 in target language in another region. For example, and without limitation, display component 1548 may display transcript text 1504 above translated text 1508, translated text 1508 above transcript text 1504, or translated text 1508 alone when limited display area is available. Advantageously, this improves accessibility for users who need captioning and translation at the same time.

With continued reference to FIG. 15, for the purposes of this disclosure, “smart glasses” are wearable glasses comprising one or more electronic components. In some cases, smart glasses may include spectacles, augmented-reality glasses, open-ear smart glasses, mixed-reality glasses, heads-up display glasses, audio glasses, or eyewear. In some embodiments, smart glasses 1532 may include audio input component 1540, display component 1548, processor 1556, memory 1560, speaker, touch sensor, temple button, wireless communication circuitry, battery, inertial measurement unit, lens, frame, or temple. In some embodiments, smart glasses 1532 may be consistent with first smart glasses 110, second smart glasses 140, smart glasses 200, and/or smart glasses 401 described with respect to FIGS. 1-14.

With continued reference to FIG. 15, in some embodiments, apparatus 1500 may further comprise smart glasses 1532, and at least one of audio input component 1540 and display component 1548 may be arranged on smart glasses 1532. As a non-limiting example, audio input component 1540 may be a directional microphone array on a temple of smart glasses 1532, and display component 1548 may be an on-lens display integrated into a lens of smart glasses 1532. In another non-limiting example, audio input component 1540 may be arranged on smart glasses 1532 while display component 1548 is arranged on companion device 1536a-b. This provides broader device coverage while supporting wearable translation and transcription.

With continued reference to FIG. 15, for the purposes of this disclosure, “companion device” is a device communicatively connectable to smart glasses or another apparatus or device. In some embodiments, companion device 1536a-b may include a device associated with a user of smart glasses 1532, a device associated with another participant in conversation, a smartphone, a smartwatch, earbuds, a wearable device, a smart terminal, other smart glasses, a conference-room hub, a factory-floor gateway, an enterprise Wi-Fi access point, a vehicle compute module, an aircraft compute module, a tablet, a laptop, an enterprise edge device, or a local server. As a non-limiting example, when a user wears smart glasses 1532, companion device 1536a may be a smartphone, smartwatch, earbuds, tablet, laptop, or wearable device associated with the same user. As another non-limiting example, when the user wears smart glasses 1532 during conversation with another person, companion device 1536b may be another smart glasses, smartphone, smartwatch, earbuds, tablet, laptop, or wearable device associated with the other person. In some embodiments, companion device 1536a-b may extend the smart mobile terminal functionality described with respect to FIGS. 1-14.

With continued reference to FIG. 15, in some embodiments, apparatus 1500 may further comprise companion device 1536a-b communicatively connected to smart glasses 1532, and at least one of audio input component 1540 and display component 1548 may be arranged on companion device 1536a-b. As a non-limiting example, companion device 1536a may be a smartphone of a user wearing smart glasses 1532, audio input component 1540 may be a microphone of the smartphone, and display component 1548 may be a screen of the smartphone. As another non-limiting example, companion device 1536a may be a smartwatch of the user wearing smart glasses 1532, audio input component 1540 may be a microphone of the smartwatch, and display component 1548 may be a watch display configured to display text content 1520. As another non-limiting example, companion device 1536b may be smart glasses 1532 worn by another participant in conversation, and text content 1520 generated by apparatus 1500 may be routed to display component 1548 of companion device 1536b. As another non-limiting example, companion device 1536b may be a smartphone or smartwatch of another participant in conversation, and translated text 1508 may be displayed by display component 1548 of companion device 1536b in a target language selected for that participant. In some embodiments, companion device 1536a-b may supplement smart glasses 1532 when smart glasses 1532 lack a display, when a larger display is preferred, when another microphone has better audio quality, or when enterprise edge processing improves privacy and computational efficiency.

With continued reference to FIG. 15, in some embodiments, companion device 1536a-b may coordinate an audio processing session between smart glasses 1532 and one or more other devices. For example, and without limitation, companion device 1536a may be a smartphone carried by the user of smart glasses 1532, companion device 1536a may receive audio data 1512 from smart glasses 1532, provide speech-to-text engine 1544 execution, provide multimodal model 1564 and/or LLM execution locally or through cloud, generate text content 1520, and send display data to smart glasses 1532. As another non-limiting example, companion device 1536a may be a smartwatch worn by the user of smart glasses 1532, companion device 1536a may receive translated text 1508 from apparatus 1500, and companion device 1536a may display a shortened portion of text content 1520 while smart glasses 1532 display another portion of text content 1520. As another non-limiting example, companion device 1536b may be smart glasses 1532 worn by another participant in conversation, and companion device 1536b may receive translated text 1508 or audio output 1524 in a different target language, thereby supporting multi-user audio processing. As another non-limiting example, companion device 1536b may be a smartphone of another participant in conversation, and apparatus 1500 may route transcript text 1504 to display component 1548 of smart glasses 1532 and route translated text 1508 to display component 1548 of the smartphone of the other participant.

With continued reference to FIG. 15, in some embodiments, audio input component 1540 arranged on companion device 1536a-b may include earbuds worn by a user, a microphone of a smartphone, a conference-room microphone array, a vehicle microphone, an aircraft microphone, or another microphone located closer to a speaker than smart glasses 1532. Processor 1556 may compare audio quality metrics among audio sources, such as signal strength, speech confidence, noise level, reverberation, and directionality, and may select or combine audio data 1512 from one or more audio input components 1540. This technical solution may improve transcription accuracy and translation accuracy while minimizing computational waste from low-quality audio streams.

With continued reference to FIG. 15, in some embodiments, display component 1548 arranged on companion device 1536a-b may include a smartphone display, smartwatch display, tablet display, laptop display, enterprise dashboard display, vehicle display, aircraft display, or display of another participant's smart glasses 1532. Processor 1556 may determine display target 1516 such that transcript text 1504 is displayed on a larger display component 1548 and translated text 1508 is displayed on a wearable display component 1548. This routing configuration may maximize readability, minimize distraction, and improve conversation-processing performance across devices of different sizes.

With continued reference to FIG. 15, for the purposes of this disclosure, “audio output component” is a component configured to output sound generated from text content or audio data. In some embodiments, audio output component 1552 may include a speaker, open-ear speaker, bone-conduction speaker, earbud speaker, smartphone speaker, smartwatch speaker, vehicle speaker, aircraft speaker, conference-room speaker, or audio interface. In some embodiments, audio output component 1552 may be included in display component 1548 when display component 1548 is implemented as a combined output component that provides visual output and audio output.

With continued reference to FIG. 15, for the purposes of this disclosure, “audio output” is sound, or audible output generated from text content or audio data. In some embodiments, audio output 1524 may include audio generated from feedback 1528, translated speech generated from translated text 1508, playback of transcript text 1504 using text-to-speech, playback of audio data 1512 corresponding to conversation, feedback audio, pronunciation guidance, or confirmation sounds. In some embodiments, audio output 1524 may be consistent with the second speech described with respect to FIGS. 1-14 and may be generated through a text-to-speech engine configured locally, on companion device 1536a-b, or in cloud.

With continued reference to FIG. 15, in some embodiments, memory 1560 may contain instructions further configuring processor 1556 to generate and output audio output 1524 of at least a portion of text content 1520 using audio output component 1552 of display component 1548. As a non-limiting example, translated text 1508 may be converted into audio output 1524 in target language and played through audio output component 1552 of smart glasses 1532 or companion device 1536a-b. In some embodiments, processor 1556 may select speech rate, voice type, volume, and playback timing based on user settings or context of conversation. This may advantageously improve accessibility and allow a user to receive both visual and audible translation information.

With continued reference to FIG. 15, in some embodiments, display component 1548 may comprise a visual output component. In some embodiments, visual output component may include an on-lens display, screen, light-emitting display, micro-display, projection display, waveguide display, heads-up display, or indicator display. As a non-limiting example, visual output component may display transcript text 1504 as captions while audio output component 1552 generates audio output 1524 corresponding to translated text 1508.

With continued reference to FIG. 15, for the purposes of this disclosure, “conversation feedback” is output content to assist a user in understanding, responding to, continuing, or improving a conversation. In some embodiments, conversation feedback 1528 may include a reply suggestion, suggested response, suggested question, suggested clarification, suggested follow-up statement, suggested translated reply, suggested source-language reply, suggested target-language reply, detected action item, meeting-summary feedback, comprehension feedback, etiquette feedback, tone-adjustment feedback, pronunciation feedback, translation-quality feedback, transcription-confidence feedback, or warning feedback. In some embodiments, conversation feedback 1528 may be displayed by display component 1548 or provided as audio output 1524.

With continued reference to FIG. 15, in some embodiments, processor 1556 may generate conversation feedback 1528 corresponding to conversation as a function of transcript text 1504 and/or translated text 1508. As a non-limiting example, processor 1556 may determine that transcript text 1504 includes a question from another participant, and processor 1556 may generate conversation feedback 1528 comprising one or more suggested replies for the user to provide in response to the question. As another non-limiting example, processor 1556 may determine that translated text 1508 includes a request for confirmation, and processor 1556 may generate conversation feedback 1528 comprising a suggested reply such as an affirmative response, a clarification request, or a request for additional details. As another non-limiting example, processor 1556 may generate conversation feedback 1528 comprising a suggested reply in target language so that the user may select or speak the suggested reply during conversation. This may improve speed, accuracy, and efficiency of multilingual conversation by reducing the computational and cognitive challenge of formulating a response while the conversation is ongoing.

With continued reference to FIG. 15, in some embodiments, conversation feedback 1528 may be generated using a feedback model. The feedback model may include a response-generation model, intent model, dialogue-act model, conversational recommendation model, transformer model, sequence-to-sequence model, retrieval-augmented generation model, classifier, ranking model, summarization model, rule-based engine, or hybrid machine-learning model. In some embodiments, training data for the feedback model may include audio data 1512, transcript text 1504, translated text 1508, conversation histories, pairs of participant utterances and corresponding replies, human-selected reply suggestions, user-selected reply suggestions, rejected reply suggestions, meeting transcripts, customer-service dialogs, travel dialogs, enterprise dialogs, multilingual conversation examples, tone labels, intent labels, question-answer labels, clarification labels, and human-reviewed feedback messages. For example, and without limitation, the feedback model may receive transcript text 1504 and translated text 1508 as inputs and output conversation feedback 1528 comprising a ranked set of reply suggestions based on training labels identifying replies previously selected by users or human reviewers in similar conversation contexts.

With continued reference to FIG. 15, in some embodiments, processor 1556 may cause conversation feedback 1528 to be displayed by display component 1548 by formatting conversation feedback 1528 as a suggested reply card, selectable response option, overlay, notification, inline note, banner, highlighted phrase, prompt, or separate feedback region. As a non-limiting example, display component 1548 may display conversation feedback 1528 below translated text 1508, where conversation feedback 1528 includes a selectable suggested reply in source language and a corresponding translated reply in target language. As another non-limiting example, display component 1548 may display multiple conversation feedback 1528 options corresponding to different tones, such as a formal reply, concise reply, clarification reply, or follow-up question. This provides a technical advantage by improving real-time conversational response generation, minimizing delay in multilingual exchanges, and increasing accuracy of user responses during conversation.

With continued reference to FIG. 15, in some embodiments, causing at least a portion of text content 1520 to be displayed may comprise sending at least a portion of text content 1520 to display component 1548 using wireless communication. For the purposes of this disclosure, “wireless communication” is data communication between two or more devices without a wired connection. In some embodiments, wireless communication may include Bluetooth, Bluetooth Low Energy, Wi-Fi, cellular, LTE, 5G, ultra-wideband, near-field communication, ZigBee, radio frequency identification, or another wireless communication protocol. As a non-limiting example, processor 1556 may send translated text 1508 from companion device 1536a-b to display component 1548 of smart glasses 1532 using Bluetooth. This connectivity approach may be consistent with the structure of sending speech via Bluetooth described with respect to FIGS. 1-14 while broadening the transmitted content to include text content 1520.

With continued reference to FIG. 15, in some embodiments, processor 1556 may select a wireless communication protocol based on latency, throughput, signal strength, power consumption, privacy settings, available networks, device capability, and display-update speed. For example, and without limitation, processor 1556 may select Bluetooth for low-power transmission of text content 1520 to smart glasses 1532, Wi-Fi for high-throughput synchronization of transcript text 1504 to companion device 1536a-b, and cellular communication for cloud-assisted LLM processing when local resources are unavailable. This may improve computational efficiency and maintain faster display of text content 1520 under changing network conditions.

With continued reference to FIG. 15, in some embodiments, processor 1556 may transmit text content 1520 incrementally using wireless communication to reduce latency. As a non-limiting example, processor 1556 may transmit partial transcript text 1504 as soon as speech-to-text engine 1544 generates a stable phrase, transmit translated text 1508 after multimodal model 1564 and/or LLM generates target-language text, and update display component 1548 as revised text content 1520 becomes available. This streaming approach may provide a technical advantage over delayed batch processing by improving perceived speed and allowing a user to follow conversation in near real time.

With continued reference to FIG. 15, in some embodiments, processor 1556 may route transcript text 1504 to a first output device and route translated text 1508 to a second output device. In some embodiments, first output device may include display component 1548 of smart glasses 1532, and second output device may include audio output component 1552 of companion device 1536a-b. As a non-limiting example, transcript text 1504 may be displayed on smart glasses 1532, while translated text 1508 is converted to audio output 1524 and played through earbuds associated with companion device 1536a-b.

With continued reference to FIG. 15, in some embodiments, routing transcript text 1504 and translated text 1508 to different output devices may include generating device-specific output formats. As a non-limiting example, transcript text 1504 routed to display component 1548 of smart glasses 1532 may be shortened and line-wrapped for a small display region, while translated text 1508 routed to audio output component 1552 of companion device 1536a-b may be expanded into a natural spoken phrase using a text-to-speech engine. This may improve device-specific performance, minimize display size constraints, and maximize comprehension.

With continued reference to FIG. 15, in some embodiments, processor 1556 may route transcript text 1504 to first output device and translated text 1508 to second output device according to a user profile, language profile, device capability, speaker selection, privacy rule, or conversation mode. As a non-limiting example, a user who understands source language but prefers translated audio for another participant may receive transcript text 1504 on smart glasses 1532 while another participant receives audio output 1524 generated from translated text 1508 through companion device 1536b. This configuration may improve multi-user audio processing by delivering personalized outputs to different devices.

With continued reference to FIG. 15, in some embodiments, apparatus 1500 may provide a technical solution to a computational challenge associated with wearable conversation translation and transcription, where limited display size, limited processor capacity, latency, audio quality, and privacy constraints can reduce accuracy and usability. Apparatus 1500 may improve this challenge by separating audio detection, speech-to-text conversion, multimodal model 1564 and/or LLM translation, display-target determination, wireless display transmission, and output routing into coordinated operations. Advantageously, this architecture may improve speed, efficiency, performance, and accuracy while minimizing cognitive load and maximizing display usability.

With continued reference to FIG. 15, in some embodiments, apparatus 1500 may improve over audio-only translation by generating transcript text 1504 and translated text 1508 as text content 1520 and displaying text content 1520 at display target 1516. This may provide an advantage in noisy environments, enterprise environments, travel environments, and accessibility contexts because users may visually confirm speech recognition and translation outputs. As a non-limiting example, a user in a factory may see transcript text 1504 and translated text 1508 on smart glasses 1532 while audio output 1524 is routed to earbuds, thereby improving comprehension despite machinery noise.

With continued reference to FIG. 15, in some embodiments, apparatus 1500 may improve processing efficiency by using local or edge execution for speech-to-text engine 1544, multimodal model 1564 and/or LLM, or both. As a non-limiting example, companion device 1536a-b implemented as an enterprise edge device may execute speech-to-text engine 1544 and multimodal model 1564 and/or LLM locally so raw audio data 1512 does not leave an enterprise network. This configuration may minimize data exposure, reduce network latency, increase processing speed, and improve enterprise privacy while maintaining accurate transcription and translation of conversation.

With continued reference to FIG. 15, in some embodiments, apparatus 1500 may cache audio data 1512, transcript text 1504, translated text 1508, and/or text content 1520 in memory 1560 when a wireless communication link is unavailable. Processor 1556 may update display component 1548 using locally available text content 1520 and synchronize text content 1520 with companion device 1536a-b when wireless communication becomes available. This may improve robustness and performance during intermittent connectivity and may allow apparatus 1500 to continue audio processing even when cloud access or companion-device access is degraded.

With continued reference to FIG. 15, in some embodiments, apparatus 1500 may implement privacy and storage controls for audio data 1512 and text content 1520. As a non-limiting example, processor 1556 may delete raw audio data 1512 after speech-to-text engine 1544 generates transcript text 1504, store only translated text 1508, encrypt text content 1520 in memory 1560, or prevent raw audio data 1512 from being transmitted outside a local device or enterprise edge device. These operations may improve privacy while preserving useful transcript and translation data.

With continued reference to FIG. 15, in some embodiments, processor 1556 may synchronize transcript text 1504, translated text 1508, and conversation feedback 1528 across smart glasses 1532 and companion device 1536a-b. As a non-limiting example, smart glasses 1532 may display a short portion of translated text 1508, while companion device 1536a may store and display a complete translation transcript including transcript text 1504, translated text 1508, timestamps, speaker labels, and conversation feedback 1528. This may provide an advantage by allowing a user to review conversation history on a larger display while receiving immediate wearable captions.

With continued reference to FIG. 15, in some embodiments, apparatus 1500 may support session handoff between smart glasses 1532 and companion device 1536a-b. For example, and without limitation, conversation may start with audio data 1512 detected by smart glasses 1532, text content 1520 displayed on smart glasses 1532, and audio output 1524 played through smart glasses 1532, and processor 1556 may transfer the session so that companion device 1536a-b displays transcript text 1504 and generates audio output 1524 when smart glasses 1532 have low battery, limited display availability, or reduced microphone quality. This handoff may improve continuity and operational performance.

With continued reference to FIG. 15, in some embodiments, apparatus 1500 may use multiple models in a coordinated model pipeline. Speech-to-text engine 1544 may receive audio data 1512 and output transcript text 1504, multimodal model 1564 and/or LLM may receive transcript text 1504 and output translated text 1508, the display-target selection model may receive text content 1520 and device context and output display target 1516, and the feedback model may receive transcript text 1504 and translated text 1508 and output conversation feedback 1528. In some embodiments, outputs of one model may be inputs to another model, and processor 1556 may maintain timing alignment between audio data 1512, transcript text 1504, translated text 1508, display target 1516, audio output 1524, and conversation feedback 1528. With continued reference to FIG. 15, in some embodiments, the coordinated model pipeline may be trained and evaluated using source data captured from consenting users, enterprise-approved meetings, multilingual conversations, benchmark translation datasets, annotated audio recordings, corrected transcripts, human translation reviews, display usability studies, and device telemetry. Speech-to-text engine 1544 may be evaluated using word error rate, multimodal model 1564 and/or LLM may be evaluated using translation accuracy and human adequacy scores, the display-target selection model may be evaluated using reading speed and user selection agreement, and the feedback model may be evaluated using feedback relevance scores. These technical evaluations may improve accuracy, efficiency, and robustness.

With continued reference to FIG. 15, in some embodiments, apparatus 1500 may generate text content 1520 comprising both transcript text 1504 and translated text 1508 in a structured translation transcript. The translation transcript may include source-language lines, target-language lines, timestamps, speaker labels, confidence levels, and feedback. In some embodiments, transcript text 1504 described herein may be consistent with first text described with respect to FIGS. 1-14, and translated text 1508 described herein may be consistent with second text described with respect to FIGS. 1-14, while the display-target and companion-device routing features described with respect to FIG. 15 may extend those earlier translation transcript concepts.

With continued reference to FIG. 15, in some embodiments, apparatus 1500 may receive user input selecting display target 1516, source language, target language, display format, audio output 1524 settings, companion device 1536a-b, or feedback preferences. User input may be received through a button, touch sensor, voice command, gesture, application interface, smart-glasses control, or companion-device interface. As a non-limiting example, a user may select that transcript text 1504 is displayed on companion device 1536a and translated text 1508 is displayed on smart glasses 1532. Processor 1556 may store this preference in memory 1560 and apply it during future conversation sessions.

With continued reference to FIG. 15, in some embodiments, apparatus 1500 may detect a language of transcript text 1504 or audio data 1512 before translation. A language-detection model may include a speech-language classifier, text-language classifier, acoustic embedding model, transformer classifier, or hybrid model. Training data for the language-detection model may include multilingual audio recordings, paired language labels, multilingual transcripts, user-corrected language selections, and device-region settings. The language-detection model may output source language, and processor 1556 may provide source language to LLM with target language to improve translation accuracy.

With continued reference to FIG. 15, in some embodiments, apparatus 1500 may use a diarization model to identify different speakers in conversation. The diarization model may include a speaker embedding model, clustering model, neural segmentation model, voiceprint model, microphone-array localization model, or attention-based speaker separation model. Training data for the diarization model may include multi-speaker recordings, speaker identity labels, microphone-array recordings, direction-of-arrival labels, overlapping-speech annotations, and user-confirmed speaker assignments. The diarization model may output speaker-labeled portions of transcript text 1504, and LLM may translate selected speaker-labeled portions into translated text 1508.

With continued reference to FIG. 15, in some embodiments, apparatus 1500 may use text-to-speech processing to generate audio output 1524 from translated text 1508 or transcript text 1504. A text-to-speech engine may include a neural acoustic model, prosody model, vocoder, multilingual voice model, speaker-adaptation model, or streaming speech synthesis model. Training data for the text-to-speech engine may include paired text and speech recordings, voice samples, pronunciation dictionaries, prosody labels, speaker style labels, and target-language speech corpora. The text-to-speech engine may receive translated text 1508 and output audio output 1524, which audio output component 1552 may play for a user or another participant.

With continued reference to FIG. 15, in some embodiments, apparatus 1500 may perform on-device correction of transcript text 1504 or translated text 1508. Processor 1556 may receive a correction from a user through smart glasses 1532 or companion device 1536a-b, store the correction in memory 1560, and provide the correction as context to speech-to-text engine 1544 or LLM during subsequent processing. As a non-limiting example, if LLM mistranslates a technical acronym, processor 1556 may store a glossary entry and use the glossary entry to improve future translated text 1508. This may improve domain-specific accuracy and reduce repeated errors.

With continued reference to FIG. 15, in some embodiments, apparatus 1500 may adapt text content 1520 for display size and processing constraints. Processor 1556 may shorten translated text 1508, summarize transcript text 1504, collapse repeated phrases, omit filler words, or prioritize important content when display component 1548 has limited space. A summarization model may be trained using transcripts, human-generated summaries, display-size labels, user readability feedback, and task-completion labels. The summarization model may receive transcript text 1504 or translated text 1508 and output shortened text content 1520 suitable for display target 1516, thereby improving readability and visual efficiency.

With continued reference to FIG. 15, in some embodiments, apparatus 1500 may provide simultaneous visual and audio outputs. Processor 1556 may cause transcript text 1504 to be displayed by display component 1548 at display target 1516 and may generate audio output 1524 corresponding to translated text 1508 through audio output component 1552. As a non-limiting example, a user may view transcript text 1504 on smart glasses 1532 while another participant receives audio output 1524 through companion device 1536b. This technical routing may improve multi-party communication by providing personalized output modalities.

With continued reference to FIG. 15, in some embodiments, apparatus 1500 may distinguish between display data and text content 1520. Processor 1556 may generate display data based on text content 1520, display target 1516, device capabilities, and rendering constraints. Display data may include formatted text, font size, position, timing, emphasis, scrolling instructions, and display-region allocation. Processor 1556 may send the display data to display component 1548 using wireless communication, and display component 1548 may render text content 1520 at display target 1516. This distinction may improve performance because display component 1548 receives data adapted to its size and rendering capability.

With continued reference to FIG. 15, in some embodiments, apparatus 1500 may be configured such that one or more operations occur in local, cloud, hybrid, or enterprise edge processing locations. Speech-to-text engine 1544 may execute on smart glasses 1532, companion device 1536a-b, or cloud; LLM may execute on smart glasses 1532, companion device 1536a-b, enterprise edge device, or cloud; and display-target determination may execute on processor 1556 associated with any of those devices. This distributed architecture may improve scalability and reduce device size because smart glasses 1532 may offload computationally intensive operations while still presenting text content 1520 at display target 1516.

With continued reference to FIG. 15, in some embodiments, apparatus 1500 may prioritize low latency for display of transcript text 1504 and higher accuracy for display of translated text 1508. Processor 1556 may display partial transcript text 1504 generated by speech-to-text engine 1544 immediately, while LLM processes a more complete utterance to generate translated text 1508. Processor 1556 may update display component 1548 when translated text 1508 is available. This staged processing may improve speed and accuracy because the user receives fast transcript feedback without waiting for full translation completion.

With continued reference to FIG. 15, in some embodiments, apparatus 1500 may generate confidence information associated with transcript text 1504, translated text 1508, or conversation feedback 1528. A confidence model may use acoustic confidence from speech-to-text engine 1544, probability scores from LLM, language-detection confidence, speaker-diarization confidence, or historical correction rates. Training data for the confidence model may include recognized text, corrected text, translation ratings, acoustic conditions, device-source labels, and human confidence labels. Processor 1556 may display confidence indicators as part of text content 1520 or conversation feedback 1528, which may improve user trust and allow faster correction of uncertain outputs.

With continued reference to FIG. 15, in some embodiments, apparatus 1500 may provide accessibility support by displaying transcript text 1504 for same-language captioning even when translation is not required. Processor 1556 may generate translated text 1508 only when source language differs from target language, when a user requests translation, or when a language-detection model detects a non-preferred language. This approach may improve computational efficiency by avoiding unnecessary LLM translation while maintaining real-time transcription benefits.

With continued reference to FIG. 15, in some embodiments, apparatus 1500 may use smart glasses 1532 as a wearable interface and companion device 1536a-b as a processing or routing hub. As a non-limiting example, smart glasses 1532 may detect audio data 1512 and display text content 1520, while companion device 1536a-b executes speech-to-text engine 1544 and LLM. In another non-limiting example, smart glasses 1532 may execute speech-to-text engine 1544 locally, and companion device 1536a-b may execute LLM. This division may improve battery life and reduce heat in smart glasses 1532 while preserving fast translation and transcription.

With continued reference to FIG. 15, in some embodiments, companion device 1536a-b associated with another participant in conversation may receive individualized text content 1520. For example, and without limitation, processor 1556 may generate translated text 1508 in English for a first user of smart glasses 1532, translated text 1508 in Japanese for a second participant using companion device 1536b, and transcript text 1504 in source language for a supervisor using companion device 1536a. This multi-device routing may improve group communication and provide a technical advantage by tailoring outputs to different language profiles and device capabilities.

With continued reference to FIG. 15, in some embodiments, apparatus 1500 may use display target 1516 to control where text content 1520 is displayed within a visual field. For smart glasses 1532, display target 1516 may be selected to reduce occlusion of real-world objects and reduce eye strain. Processor 1556 may receive gaze information, head-position information, or scene information and adjust display target 1516 accordingly. A gaze-aware display model may be trained using gaze-tracking data, readability labels, user comfort feedback, and task-completion measurements. The gaze-aware display model may output display target 1516 to improve usability of text content 1520 in wearable displays.

With continued reference to FIG. 15, in some embodiments, apparatus 1500 may implement a low-power mode. Processor 1556 may reduce sampling rate of audio input component 1540, use a smaller speech-to-text engine 1544, delay LLM translation, reduce display refresh rate of display component 1548, or route processing to companion device 1536a-b. This may minimize power consumption and maximize battery life while maintaining essential audio processing functions.

With continued reference to FIG. 15, in some embodiments, apparatus 1500 may implement an enterprise privacy mode. Processor 1556 may determine that LLM is executed on companion device 1536a-b implemented as an enterprise edge device, prevent audio data 1512 from being sent to a public cloud server, delete raw audio data 1512 after transcript text 1504 is generated, and encrypt text content 1520 in memory 1560. This may solve a technical problem of secure multilingual transcription in enterprise environments while improving processing speed by using local edge resources.

With continued reference to FIG. 15, in some embodiments, apparatus 1500 may generate audit or storage records from text content 1520. Processor 1556 may store transcript text 1504, translated text 1508, conversation feedback 1528, display target 1516 selections, and output routing events in memory 1560 or companion device 1536a-b. Storage may be temporary, user-controlled, encrypted, enterprise-managed, or session-limited. This may allow review of conversation while minimizing unnecessary retention of audio data 1512.

With continued reference to FIG. 15, in some embodiments, apparatus 1500 may support interaction between conversation feedback 1528 and display target 1516. Processor 1556 may determine that conversation feedback 1528 is urgent and may display conversation feedback 1528 at a more prominent display target 1516 than transcript text 1504. As a non-limiting example, if speech-to-text engine 1544 detects low audio quality or LLM detects ambiguity, conversation feedback 1528 may be displayed in a central display region, while transcript text 1504 remains in a lower display region. This may improve real-time response to errors and increase translation reliability.

With continued reference to FIG. 15, in some embodiments, apparatus 1500 may determine that audio data 1512 includes speech from multiple speakers and generate transcript text 1504 with speaker labels. Processor 1556 may translate different speaker-labeled portions into different translated text 1508 outputs and route those outputs to different display targets 1516 or companion devices 1536a-b. This may improve performance in group conversations because apparatus 1500 does not need to treat all speech as a single continuous stream.

With continued reference to FIG. 15, in some embodiments, apparatus 1500 may determine display target 1516 using an optimization process. The optimization process may evaluate candidate display targets 1516 according to readability, latency, privacy, display size, power consumption, and user preference. The optimization process may select the candidate display target 1516 with a highest utility score or a lowest cost score. Training data for a learned optimization component may include user selections, read-time measurements, device context, text content 1520 length, and satisfaction labels. This may improve display efficiency and maximize comprehension.

With continued reference to FIG. 15, in some embodiments, apparatus 1500 may maintain synchronization between audio data 1512, transcript text 1504, translated text 1508, audio output 1524, and display timing. Processor 1556 may associate portions of text content 1520 with time positions in audio data 1512, and display component 1548 may display text content 1520 at timing aligned to the spoken conversation. As a non-limiting example, translated text 1508 may appear after transcript text 1504 with a delay determined by LLM processing time, and processor 1556 may compensate for the delay by presenting phrase-level chunks rather than word-level chunks.

With continued reference to FIG. 15, in some embodiments, apparatus 1500 may receive audio data 1512 from one device and display text content 1520 on another device. As a non-limiting example, companion device 1536a-b implemented as a conference-room hub may detect audio data 1512 from multiple participants, processor 1556 may generate transcript text 1504 and translated text 1508, and display component 1548 of smart glasses 1532 may display text content 1520 at display target 1516. This arrangement may improve accuracy because conference-room microphones may capture better audio than a wearable microphone in some environments.

With continued reference to FIG. 15, in some embodiments, apparatus 1500 may provide interoperability with the translation transcript storage and sharing operations described with respect to FIGS. 1-14. Processor 1556 may generate text content 1520 comprising transcript text 1504 and translated text 1508, store text content 1520 in memory 1560 or companion device 1536a-b and share text content 1520 to another terminal or platform according to a user action. This extension may add display-target selection, companion-device routing, and conversation feedback 1528 to the transcript concepts described in the earlier figures.

With continued reference to FIG. 15, in some embodiments, apparatus 1500 may be implemented with smart glasses 1532 having no integrated display component 1548, where display component 1548 is arranged on companion device 1536a-b. In other embodiments, apparatus 1500 may be implemented with smart glasses 1532 having display component 1548 and companion device 1536a-b having audio input component 1540. These arrangements may broaden hardware configurations and reduce device-size challenges because each device can contribute components according to its strengths.

With continued reference to FIG. 15, in some embodiments, smart glasses 1532 and/pr apparatus 1500 may include a camera configured to acquire visual data associated with a speaker, a mouth region of the speaker, facial movement of the speaker, lip movement of the speaker, a gesture of the speaker, or another visually detectable feature associated with audio data 1512. In some embodiments, processor 1556 may determine that audio data 1512 detected by audio input component 1540 is insufficient for generating transcript text 1504 when audio data 1512 has a signal-to-noise ratio below a threshold value, when audio data 1512 includes overlapping speech, when audio data 1512 includes machinery noise, wind noise, vehicle noise, aircraft noise, crowd noise, echo, or reverberation, when speech-to-text engine 1544 generates transcript text 1504 with a confidence score below a threshold value, or when audio input component 1540 fails to acquire a complete portion of speech. In response, processor 1556 may activate the camera of smart glasses 1532 to acquire visual data corresponding to the speaker.

With continued reference to FIG. 15, in some embodiments, processor 1556 may implement a hybrid audio-visual transcription mode in which audio data 1512 and visual data acquired by the camera are both used as input data for generating transcript text 1504 or text content 1520. As a non-limiting example, audio input component 1540 may detect partial audio data 1512 corresponding to speech of another participant in a noisy factory-floor environment, and the camera of smart glasses 1532 may acquire visual data corresponding to lip movement of the other participant. Processor 1556 may provide audio data 1512 and the visual data to speech-to-text engine 1544, multimodal model 1564, or another audio-visual speech recognition model to generate transcript text 1504 with improved accuracy relative to using audio data 1512 alone.

With continued reference to FIG. 15, in some embodiments, multimodal model 1564 may be configured to perform lip-reading interpretation, visual speech recognition, audio-visual speech recognition, or speech disambiguation using visual data from the camera of smart glasses 1532. Multimodal model 1564 may include an audio encoder configured to process audio data 1512, a visual encoder configured to process image frames or video frames of a mouth region, an attention mechanism configured to align audio features with visual speech features, and a decoder configured to output transcript text 1504. In some embodiments, multimodal model 1564 may receive audio data 1512 and visual data as inputs and output transcript text 1504, translated text 1508, text content 1520, confidence text, or conversation feedback 1528.

With continued reference to FIG. 15, in some embodiments, training data for multimodal model 1564 may include paired audio recordings and video recordings of speakers, mouth-region image sequences, lip-movement labels, phoneme labels, viseme labels, transcript labels, source-language labels, target-language labels, noisy-audio examples, clean-audio examples, and human-corrected transcripts. For example, and without limitation, a training example may include audio data 1512 of a spoken utterance mixed with background noise, corresponding visual data showing lip movement of the speaker, and transcript text 1504 manually labeled for the spoken utterance. Multimodal model 1564 may be trained to map the audio data 1512 and visual data to transcript text 1504, thereby improving transcription accuracy when audio input component 1540 cannot acquire complete or sufficiently clear audio data 1512.

With continued reference to FIG. 15, in some embodiments, processor 1556 may use a confidence-based switching process to determine whether to use audio-only processing, visual-only processing, or hybrid audio-visual processing. As a non-limiting example, processor 1556 may initially provide audio data 1512 to speech-to-text engine 1544 to generate transcript text 1504 and may determine a transcription confidence score. When the transcription confidence score fails to satisfy a threshold value, processor 1556 may activate the camera of smart glasses 1532 and provide visual data from the camera and audio data 1512 to multimodal model 1564. In some embodiments, when audio data 1512 is unavailable, corrupted, or below a minimum quality threshold, processor 1556 may generate transcript text 1504 using visual data acquired by the camera.

With continued reference to FIG. 15, in some embodiments, translated text 1508 may be generated using transcript text 1504 generated from the hybrid audio-visual transcription mode. As a non-limiting example, after multimodal model 1564 generates transcript text 1504 from audio data 1512 and visual data, multimodal model 1564 or another translation model may translate at least a portion of transcript text 1504 in a source language to obtain translated text 1508 in a target language. Processor 1556 may then generate text content 1520 including transcript text 1504 and translated text 1508, determine display target 1516, and cause text content 1520 to be displayed by display component 1548 at display target 1516.

With continued reference to FIG. 15, in some embodiments, use of the camera of smart glasses 1532 may provide a technical solution to a technical problem associated with insufficient audio acquisition in noisy or acoustically degraded environments. The hybrid audio-visual processing may improve accuracy of transcript text 1504, improve speed of disambiguating unclear speech, increase performance of translation into translated text 1508, minimize transcription errors caused by low-quality audio data 1512, and advantageously allow apparatus 1500 to continue conversation processing when audio input component 1540 alone is unreliable.

With continued reference to FIG. 15, in some embodiments, apparatus 1500 may use local language packages to support speech-to-text engine 1544 or LLM when network access is limited. A language package may include vocabulary data, acoustic parameters, translation model weights, tokenizer data, grammar constraints, pronunciation data, or glossary data. Training data for language packages may include domain-specific terminology, user-corrected transcript text 1504, enterprise terminology lists, and bilingual sentence pairs. This may improve speed and privacy by allowing apparatus 1500 to generate transcript text 1504 and translated text 1508 without remote processing.

With continued reference to FIG. 15, in some embodiments, apparatus 1500 may dynamically switch between local and cloud processing for speech-to-text engine 1544 and LLM. Processor 1556 may select local processing when privacy settings require local operation or when latency is lower locally, and processor 1556 may select cloud processing when larger model capacity is needed. This may improve computational performance by balancing model size, processing speed, power, and accuracy.

With continued reference to FIG. 15, in some embodiments, apparatus 1500 may use LLM to generate translated text 1508 and conversation feedback 1528 in a single model call or in separate model calls. As a non-limiting example, LLM may first translate transcript text 1504 into translated text 1508, and a feedback model or second prompt to LLM may evaluate whether translated text 1508 contains uncertainty. Training data for this process may include translated sentences, human correction labels, ambiguity labels, and feedback examples. This may improve efficiency by sharing contextual representations across translation and feedback generation.

With continued reference to FIG. 15, in some embodiments, apparatus 1500 may support modular replacement of speech-to-text engine 1544, LLM, display-target selection model, and feedback model. Processor 1556 may select a model based on language pair, latency requirement, privacy setting, device capability, or enterprise policy. For example, and without limitation, a smaller LLM may be used on smart glasses 1532 for faster response, while a larger LLM may be used on companion device 1536a-b or cloud for higher translation accuracy. This modularity may advance system flexibility and scalability.

With continued reference to FIG. 15, in some embodiments, apparatus 1500 may minimize displayed text size by selecting portions of text content 1520 for display at display target 1516. Processor 1556 may select a current utterance, a most recent translated phrase, a high-priority action item, or a speaker-specific phrase. This may solve a technical problem associated with limited smart-glasses display area while maintaining useful information flow.

With continued reference to FIG. 15, in some embodiments, apparatus 1500 may maximize readability by determining display target 1516 based on display component 1548 characteristics. Processor 1556 may access display resolution, brightness, contrast, field-of-view position, refresh rate, and available area, and may adjust text content 1520 accordingly. As a non-limiting example, translated text 1508 displayed on a micro-display may be shortened, while transcript text 1504 displayed on a smartphone display may include full punctuation and timestamps.

With continued reference to FIG. 15, in some embodiments, apparatus 1500 may provide a technical advantage by allowing display target 1516 to refer to both a device and a region within a device. This avoids limiting apparatus 1500 to a plurality of display components and permits a single display component 1548 to support multiple display regions. As a non-limiting example, display target 1516 may be a lower caption region of display component 1548 of smart glasses 1532, and a separate display target 1516 may be a transcript history region of display component 1548 of companion device 1536a-b.

With continued reference to FIG. 15, in some embodiments, apparatus 1500 may be used in a travel environment, enterprise environment, healthcare environment, educational environment, manufacturing environment, vehicle environment, aircraft environment, meeting environment, or consumer conversation environment. In each environment, audio data 1512 may be detected, transcript text 1504 may be generated, translated text 1508 may be generated, display target 1516 may be determined, and text content 1520 may be displayed by display component 1548. This broad implementation flexibility may improve user accessibility and communication efficiency.

With continued reference to FIG. 15, in some embodiments, apparatus 1500 may include a mobile application installed on companion device 1536a-b. The mobile application may configure source language, target language, display target 1516, audio output 1524, conversation feedback 1528, wireless communication settings, and storage preferences. The mobile application may be consistent with the mobile APP described with respect to FIGS. 1-14 while supporting the additional display-target and companion-device features of FIG. 15.

With continued reference to FIG. 15, in some embodiments, apparatus 1500 may include a client application installed on smart glasses 1532. The client application may control audio input component 1540, display component 1548, audio output component 1552, and communication with companion device 1536a-b. As a non-limiting example, the client application may receive display data corresponding to translated text 1508 from companion device 1536a-b and render translated text 1508 at display target 1516 within display component 1548 of smart glasses 1532.

With continued reference to FIG. 15, in some embodiments, apparatus 1500 may detect the end of a speech segment using voice activity detection, silence detection, punctuation prediction, speaker-turn detection, or inertial measurement data. Speech-to-text engine 1544 may generate transcript text 1504 for the segment, and LLM may translate the segment into translated text 1508. This may improve speed by allowing phrase-level translation rather than waiting for an entire conversation to end.

With continued reference to FIG. 15, in some embodiments, processor 1556 may handle overlapping speech by segmenting audio data 1512 into speaker-specific streams. A source-separation model may be trained using mixed-speaker audio, isolated-speaker references, overlap labels, and microphone-array spatial labels. The source-separation model may receive audio data 1512 and output separated audio streams, which speech-to-text engine 1544 may convert into speaker-specific transcript text 1504. LLM may translate speaker-specific transcript text 1504 into translated text 1508 for display or routing.

With continued reference to FIG. 15, in some embodiments, apparatus 1500 may improve accuracy of LLM by providing metadata generated by speech-to-text engine 1544. Metadata may include punctuation, speaker identity, language confidence, utterance boundaries, domain terms, timestamps, and confidence values. LLM may use this metadata to generate translated text 1508 that preserves speaker intent and context. This technical interaction may reduce mistranslation and improve naturalness of translated text 1508.

With continued reference to FIG. 15, in some embodiments, apparatus 1500 may reduce display latency by separating stable and unstable transcript text 1504. Speech-to-text engine 1544 may output a stable portion and a provisional portion. Processor 1556 may display the stable portion immediately at display target 1516 and delay or visually distinguish the provisional portion until confidence increases. LLM may translate only stable transcript text 1504 or may translate provisional transcript text 1504 and later revise translated text 1508. This may improve real-time performance while minimizing display flicker.

With continued reference to FIG. 15, in some embodiments, apparatus 1500 may support playback of conversation by associating text content 1520 with corresponding audio data 1512. Processor 1556 may store an index between transcript text 1504 and audio data 1512, and audio output component 1552 may play audio output 1524 corresponding to a selected portion of transcript text 1504 or translated text 1508. This may allow a user to review a portion of conversation and improves usability for meetings, training, or enterprise documentation.

With continued reference to FIG. 15, in some embodiments, apparatus 1500 may display conversation feedback 1528 in association with a specific portion of transcript text 1504 or translated text 1508. As a non-limiting example, display component 1548 may display an icon adjacent to a phrase in translated text 1508 to indicate low confidence, a detected ambiguity, or an available alternate translation. This may improve accuracy by guiding a user to review only the portions of text content 1520 likely to require attention.

With continued reference to FIG. 15, in some embodiments, apparatus 1500 may incorporate user correction into future operation. Processor 1556 may receive a correction to transcript text 1504, translated text 1508, display target 1516, or conversation feedback 1528, store the correction in memory 1560, and use the correction to update prompts, glossary entries, personalization data, or model selection. Training data for personalization may include user-corrected text, preferred translations, display-target selections, and feedback dismissal events. This may improve future performance and reduce repeated correction burden.

With continued reference to FIG. 15, in some embodiments, apparatus 1500 may provide secure communication between smart glasses 1532 and companion device 1536a-b. Processor 1556 may encrypt audio data 1512, transcript text 1504, translated text 1508, text content 1520, display data, or conversation feedback 1528 before transmission. This may minimize privacy risk while preserving fast transmission of display data. As a non-limiting example, translated text 1508 may be encrypted before being sent to display component 1548 of smart glasses 1532 using wireless communication.

With continued reference to FIG. 15, in some embodiments, apparatus 1500 may detect device capability of smart glasses 1532 and companion device 1536a-b before determining display target 1516. Device capability may include display availability, audio output availability, processor capacity, memory capacity, battery state, network state, microphone quality, privacy setting, and supported languages. Processor 1556 may route text content 1520 to display component 1548 of the device with the most suitable capability. This may improve efficiency and reduce processing burden on small wearable devices.

With continued reference to FIG. 15, in some embodiments, apparatus 1500 may support a mode in which transcript text 1504 is displayed without translated text 1508. Processor 1556 may generate text content 1520 comprising transcript text 1504, determine display target 1516, and cause transcript text 1504 to be displayed. In other embodiments, apparatus 1500 may support a mode in which translated text 1508 is displayed without transcript text 1504. This flexibility may support caption-only and translation-only use cases while remaining consistent with the broader generation of text content 1520.

With continued reference to FIG. 15, in some embodiments, apparatus 1500 may generate text content 1520 by combining outputs from speech-to-text engine 1544 and LLM with formatting generated by processor 1556. Formatting may include identifying transcript text 1504 as source-language content and translated text 1508 as target-language content, indicating speaker identity, and aligning each translated phrase with corresponding transcript text 1504. This may allow display component 1548 to render a clear bilingual transcript.

With continued reference to FIG. 15, in some embodiments, apparatus 1500 may display text content 1520 by scrolling, replacing, fading, pinning, or stacking portions of text content 1520 at display target 1516. For smart glasses 1532, processor 1556 may limit displayed lines to reduce obstruction. For companion device 1536a-b, processor 1556 may display a longer transcript history. This improves display efficiency across different display sizes.

With continued reference to FIG. 15, in some embodiments, apparatus 1500 may coordinate with the cloud server concepts described with respect to FIGS. 1-14. Processor 1556 may send transcript text 1504 to a cloud-hosted LLM, receive translated text 1508, and cause translated text 1508 to be displayed at display target 1516. In other embodiments, processor 1556 may execute LLM locally to reduce latency and improve privacy.

With continued reference to FIG. 15, in some embodiments, apparatus 1500 may be configured so that the speech-to-text engine 1544 is located in a different device than LLM. As a non-limiting example, speech-to-text engine 1544 may be executed on companion device 1536a-b to convert audio data 1512 into transcript text 1504, while LLM may be executed on an enterprise edge device to generate translated text 1508. Processor 1556 may coordinate the data flow and determine display target 1516 for displaying text content 1520. This separation may improve computational performance and reduce load on smart glasses 1532.

With continued reference to FIG. 15, in some embodiments, apparatus 1500 may use an enterprise edge device as companion device 1536a-b. The enterprise edge device may include a conference-room hub, factory-floor gateway, enterprise Wi-Fi access point, vehicle compute module, or aircraft compute module. The enterprise edge device may perform speech-to-text processing, LLM translation, display routing, audio output 1524 generation, storage, or privacy enforcement. This may improve speed and reduce dependence on public cloud resources.

With continued reference to FIG. 15, in some embodiments, apparatus 1500 may provide a technical solution that improves translation workflows by allowing transcript text 1504 and translated text 1508 to be routed separately. In the original translation workflows, translated speech playback and translated text display may be performed through smart glasses or smart mobile terminals; apparatus 1500 may extend this architecture by determining display target 1516 and routing different portions of text content 1520 to different output devices. This improves flexibility and user comprehension.

With continued reference to FIG. 15, in some embodiments, apparatus 1500 may be configured to display only a portion of text content 1520 at display target 1516. Processor 1556 may select the portion based on recency, importance, speaker identity, translation confidence, display size, or user selection. As a non-limiting example, processor 1556 may display only translated text 1508 for the most recent utterance on smart glasses 1532, while storing full transcript text 1504 and translated text 1508 on companion device 1536a-b. This improves display efficiency and minimizes visual clutter.

With continued reference to FIG. 15, in some embodiments, apparatus 1500 may use conversation feedback 1528 to change processing behavior. If conversation feedback 1528 indicates low transcription confidence, processor 1556 may increase microphone gain, switch audio input component 1540, request repetition, or route audio data 1512 to a higher-accuracy speech-to-text engine 1544. If conversation feedback 1528 indicates low translation confidence, processor 1556 may send additional context to LLM or use a larger LLM. This closed-loop operation may improve accuracy and performance.

With continued reference to FIG. 15, in some embodiments, apparatus 1500 may display conversation feedback 1528 together with transcript text 1504 or translated text 1508 at display target 1516. As a non-limiting example, display component 1548 may display translated text 1508 and a message that the translation uses a literal interpretation. This may help a user decide whether to rely on the translation or request clarification, thereby improving communication reliability.

With continued reference to FIG. 15, in some embodiments, apparatus 1500 may support communication with multiple companion devices 1536a-b. Processor 1556 may identify a companion device 1536a associated with the user and a companion device 1536b associated with another participant. Processor 1556 may send text content 1520 to companion device 1536a in one target language and send text content 1520 to companion device 1536b in another target language. This provides a scalable multi-device architecture for multi-language conversations.

With continued reference to FIG. 15, in some embodiments, apparatus 1500 may support device-specific privacy rules. Processor 1556 may display transcript text 1504 on smart glasses 1532 but prevent transcript text 1504 from being sent to companion device 1536b associated with another participant unless a sharing permission is satisfied. Processor 1556 may also display translated text 1508 on companion device 1536b without sharing full transcript history. This may provide privacy-preserving audio processing.

With continued reference to FIG. 15, in some embodiments, apparatus 1500 may provide a user interface that allows selection of display target 1516. The user interface may be displayed on display component 1548 of smart glasses 1532 or companion device 1536a-b. Processor 1556 may receive a selection identifying a display region or device for text content 1520 and may apply the selected display target 1516 to subsequent transcript text 1504 or translated text 1508. This may improve usability by allowing user-controlled display routing.

With continued reference to FIG. 15, in some embodiments, apparatus 1500 may generate text content 1520 with reduced latency by using predictive translation. LLM may receive partial transcript text 1504 and generate provisional translated text 1508 before an utterance is complete. Processor 1556 may display provisional translated text 1508 with an indicator and update the provisional translated text 1508 when final transcript text 1504 is available. Training data for predictive translation may include partial utterances, complete utterances, and final translations. This may improve speed while preserving accuracy through later refinement.

With continued reference to FIG. 15, in some embodiments, apparatus 1500 may include safeguards for hallucination or translation drift by comparing translated text 1508 to transcript text 1504 using a consistency model. The consistency model may be trained using source text, correct translations, incorrect translations, adequacy labels, and semantic similarity scores. The consistency model may receive transcript text 1504 and translated text 1508 and output a consistency score. Processor 1556 may generate conversation feedback 1528 or request retranslation when the consistency score fails a threshold. This may improve reliability of LLM translation.

With continued reference to FIG. 15, in some embodiments, apparatus 1500 may perform domain adaptation for LLM using context from companion device 1536a-b. As a non-limiting example, companion device 1536a-b may provide calendar context, meeting title, enterprise location, device role, or user-selected domain, and LLM may use that context to generate translated text 1508. Training data for domain adaptation may include domain-labeled transcripts, bilingual terminology, enterprise glossaries, and corrected translations. This may improve technical-term accuracy in specialized environments.

With continued reference to FIG. 15, in some embodiments, apparatus 1500 may generate audio output 1524 based on translated text 1508 while causing transcript text 1504 to be displayed. This may allow a user to visually monitor source-language speech while another device provides target-language speech output. As a non-limiting example, first output device may comprise display component 1548 of smart glasses 1532 and second output device may comprise audio output component 1552 of companion device 1536a-b.

With continued reference to FIG. 15, in some embodiments, apparatus 1500 may maintain a session state for conversation. The session state may include source language, target language, active audio input component 1540, active display component 1548, display target 1516, active companion device 1536a-b, selected speech-to-text engine 1544, selected LLM, and output-routing preferences. Processor 1556 may store the session state in memory 1560 and update the session state as devices join, leave, or change capability. This may improve continuity during session handoff.

With continued reference to FIG. 15, in some embodiments, apparatus 1500 may compress text content 1520 before sending text content 1520 to display component 1548 using wireless communication. Processor 1556 may transmit only changes from prior text content 1520, only newly generated translated text 1508, or only display commands corresponding to changed display regions. This may improve bandwidth efficiency and reduce power consumption for smart glasses 1532.

With continued reference to FIG. 15, in some embodiments, apparatus 1500 may provide a faster display path for transcript text 1504 and a higher-accuracy path for translated text 1508. Speech-to-text engine 1544 may operate in a streaming mode to provide transcript text 1504 quickly, while LLM may use a longer context window to generate translated text 1508. Processor 1556 may cause transcript text 1504 to be displayed first and translated text 1508 to be displayed after translation is complete. This staged display may improve perceived responsiveness and maintain translation accuracy.

With continued reference to FIG. 15, in some embodiments, apparatus 1500 may detect that display component 1548 is unavailable, disabled, occupied, or unsuitable, and processor 1556 may determine a different display target 1516. As a non-limiting example, if display component 1548 of smart glasses 1532 is not available, processor 1556 may determine that display target 1516 is display component 1548 of companion device 1536a-b. This may improve robustness and prevent loss of transcript and translation information.

With continued reference to FIG. 15, in some embodiments, apparatus 1500 may detect that audio input component 1540 on smart glasses 1532 is obstructed or noisy, and processor 1556 may receive audio data 1512 from audio input component 1540 arranged on companion device 1536a-b. The selection may be based on acoustic quality metrics. This may improve speech-to-text accuracy and reduce computational errors caused by poor audio.

With continued reference to FIG. 15, in some embodiments, apparatus 1500 may use the audio data 1512, transcript text 1504, translated text 1508, display target 1516, audio output 1524, and conversation feedback 1528 to create an adaptive audio processing loop. Processor 1556 may monitor output quality and user interaction, update model selection, update display target 1516, update routing, and update feedback generation. This adaptive loop may improve performance over time and provide a technical solution for real-time multilingual wearable communication.

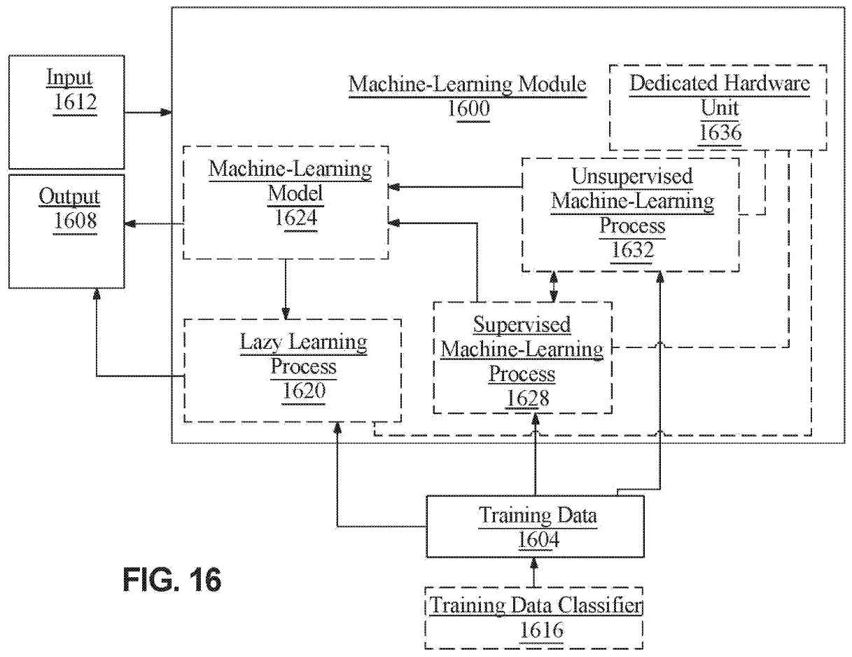

Referring now to FIG. 16, an exemplary embodiment of a machine-learning module 1600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1604 to generate an algorithm instantiated in hardware or software logic, data structures, and/or functions that will be performed by a computing device/module to produce outputs 1608 given data provided as inputs 1612; this is in contrast to a non-machine learning software program where the commands to be executed are determined in advance by a user and written in a programming language.

Still referring to FIG. 16, “training data,” as used herein, is data containing correlations that a machine-learning process may use to model relationships between two or more categories of data elements. For instance, and without limitation, training data 1604 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1604 according to various correlations; correlations may indicate causative and/or predictive links between categories of data elements, which may be modeled as relationships such as mathematical relationships by machine-learning processes as described in further detail below. Training data 1604 may be formatted and/or organized by categories of data elements, for instance by associating data elements with one or more descriptors corresponding to categories of data elements. As a non-limiting example, training data 1604 may include data entered in standardized forms by persons or processes, such that entry of a given data element in a given field in a form may be mapped to one or more descriptors of categories. Elements in training data 1604 may be linked to descriptors of categories by tags, tokens, or other data elements; for instance, and without limitation, training data 1604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 16, training data 1604 may include one or more elements that are not categorized; that is, training data 1604 may not be formatted or contain descriptors for some elements of data. Machine-learning algorithms and/or other processes may sort training data 1604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1604 to be made applicable for two or more distinct machine-learning algorithms as described in further detail below. Training data 1604 used by machine-learning module 1600 may correlate any input data as described in this disclosure to any output data as described in this disclosure. As a non-limiting illustrative example, training data 1604 may correlate audio data including one or more spoken utterances in a source language to transcript text generated from the one or more spoken utterances, translated text generated from the transcript text in a target language, display target data indicating a display component or display region selected for displaying text content, and/or conversation feedback comprising a suggested reply, suggested clarification, or suggested follow-up statement corresponding to the conversation.

Further referring to FIG. 16, training data may be filtered, sorted, and/or selected using one or more supervised and/or unsupervised machine-learning processes and/or models as described in further detail below; such models may include without limitation a training data classifier 1616. Training data classifier 1616 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1600 may generate a classifier using a classification algorithm, defined as a process whereby a computing device and/or any module and/or component operating thereon derives a classifier from training data 1604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1616 may classify elements of training data to a conversation-processing cohort associated with one or more shared characteristics, such as a source language, a target language, an acoustic environment of audio data, a device type associated with audio input component or display component, a display target, a speaker category, a conversation type, a transcription-confidence range, user demographic including age, occupation, gender, and the like, a translation-confidence range, or a feedback category associated with conversation feedback, such that a subset of training data may be selected for training a speech-to-text engine, LLM, display-target selection model, or conversation-feedback model for the corresponding cohort.

Still referring to FIG. 16, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 16, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 16, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 16, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 16, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 16, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 16, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 16, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 16, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 16, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 16, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{n e w} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Further referring to FIG. 16, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 16, machine-learning module 1600 may be configured to perform a lazy-learning process 1620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1604. Heuristic may include selecting some number of highest-ranking associations and/or training data 1604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 16, machine-learning processes as described in this disclosure may be used to generate machine-learning models 1624. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1624 may be generated by creating an artificial neural network, such as a convolutional neural network comprising an input layer of nodes, one or more intermediate layers, and an output layer of nodes. Connections between nodes may be created via the process of “training” the network, in which elements from a training data 1604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 16, machine-learning algorithms may include at least a supervised machine-learning process 1628. At least a supervised machine-learning process 1628, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include audio data, transcript text, translated text, source language data, target language data, display component data, audio input component data, display-region data, device-capability data, wireless-communication data, conversation-context data, speaker data, and/or user-selection data as described above as inputs, text content, display target, conversation feedback, translated text, transcript text, audio output, routing instructions, and/or confidence scores associated with transcript text or translated text as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1604. Persons skilled in the art, upon reviewing the entirety of this disclosure, will be aware of various possible variations of at least a supervised machine-learning process 1628 that may be used to determine relation between inputs and outputs. Supervised machine-learning processes may include classification algorithms as defined above.

With further reference to FIG. 16, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including, without limitation, gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 16, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 16, machine learning processes may include at least an unsupervised machine-learning processes 1632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1632 may not require a response variable; unsupervised processes 1632may be used to find interesting patterns and/or inferences between variables, to determine a degree of correlation between two or more variables, or the like.

Still referring to FIG. 16, machine-learning module 1600 may be designed and configured to create a machine-learning model 1624 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 16, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including, without limitation, support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 16, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 16, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 16, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 16, one or more processes or algorithms described above may be performed by at least a dedicated hardware unit 1636. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1636 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1636 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1636 to perform one or more operations described herein, such as evaluation of model and/or algorithm outputs, one-time or iterative updates to parameters, coefficients, weights, and/or biases, and/or any other operations such as vector and/or matrix operations as described in this disclosure.

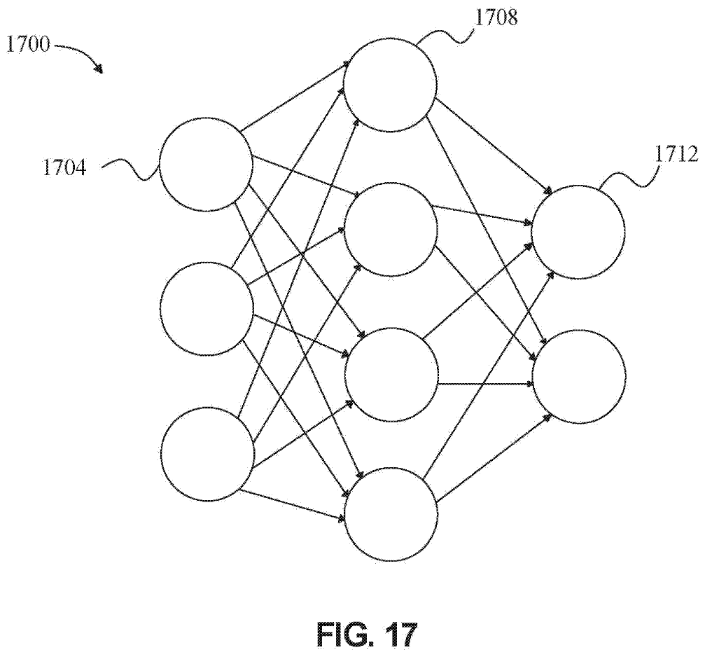

Referring now to FIG. 17, an exemplary embodiment of neural network 1700 is illustrated. A neural network 1700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1704, one or more intermediate layers 1708, and an output layer of nodes 1712. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

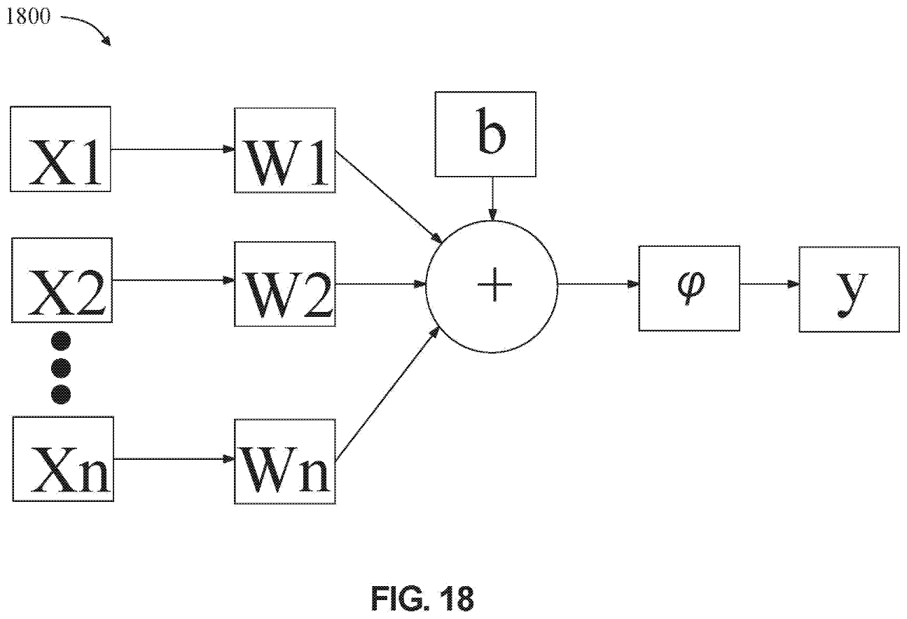

Referring now to FIG. 18, an exemplary embodiment of a node 1800 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x & for x \geq 0 \\ α ( {e}^{x} - 1 ) & for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) & for x < 0 \\ x & for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, or of other coefficients and/or parameters of an activation function, may be determined by training a neural network using training data, which may be performed using any suitable process as described above. Each weight in a neural network may, without limitation, be updated and/or tuned, based on an error function J, using a backpropagation updating method, such as:

$${w}_{n e w} = {w}_{o l d} - α \frac{d J}{d w}$$

where w_{new} is the updated weight value, w_{old} is the previous weight value, α is a parameter to set the learning rate, and

$$\frac{dJ}{dw}$$

is the partial derivative of with respect to weight w.

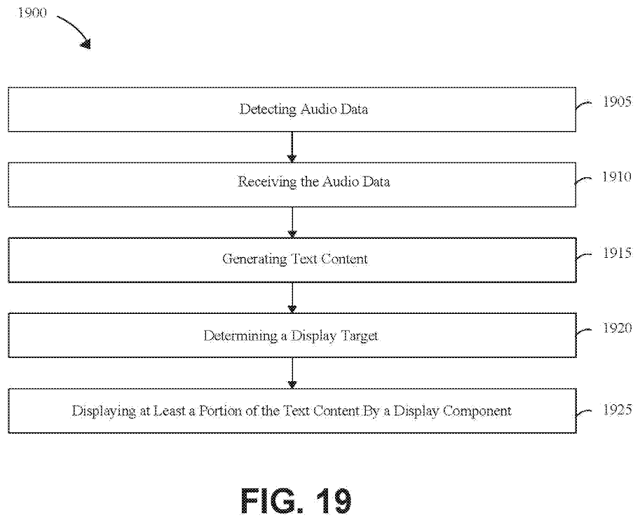

Referring now to FIG. 19, a flow diagram of an exemplary method 1900 of audio processing is illustrated. Method 1900 contains a step 1905 of detecting, using an audio input component, audio data. This may be implemented as described and with reference to FIGS. 1-18.

With continued reference to FIG. 19, method 1900 contains a step 1910 of receiving, using at least a processor, audio data from an audio input component. This may be implemented as described and with reference to FIGS. 1-18.

With continued reference to FIG. 19, method 1900 contains a step 1915 of generating, using at least a processor, text content as a function of audio data. In some embodiments, generating the text content as a function of the audio data further may include translating, using a multimodal model, at least a portion of the text content including transcript text, wherein at least a portion of the transcript text in a source language may be translated to obtain translated text in a target language. In some embodiments, method 1900 may further include routing, using the at least a processor, the transcript text to a first output device, and routing, using the at least a processor, the translated text to a second output device, wherein the first output device may include the display component of smart glasses and the second output device may include an audio output device of a companion device. This may be implemented as described and with reference to FIGS. 1-18.

With continued reference to FIG. 19, method 1900 contains a step 1920 of determining, using at least a processor, a display target for at least a portion of text content. In some embodiments, determining the display target may include determining a device on which the at least a portion of the text content may be to be displayed. This may be implemented as described and with reference to FIGS. 1-18.

With continued reference to FIG. 19, method 1900 contains a step 1925 of displaying, using at least a processor, at least a portion of text content by a display component at a display target. In some embodiments, an audio input component or the display component may be arranged on smart glasses. In some embodiments, the smart glasses may be communicatively connected to a companion device via wireless or wired connectivity, and one of the audio input component and the display component may be arranged on the companion device. In some embodiments, method 1900 may further include generating and providing, using the at least a processor, an audio output of at least a portion of the text content using an audio output component of the display component. In some embodiments, the display component may include a visual output component. In some embodiments, method 1900 may further include generating, by the at least a processor, feedback as a function of the text content, and displaying, by the at least a processor, the feedback by the display component. In some embodiments, displaying the at least a portion of the text content may include sending the at least a portion of the text content to the display component using wireless communication. This may be implemented as described and with reference to FIGS. 1-18.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

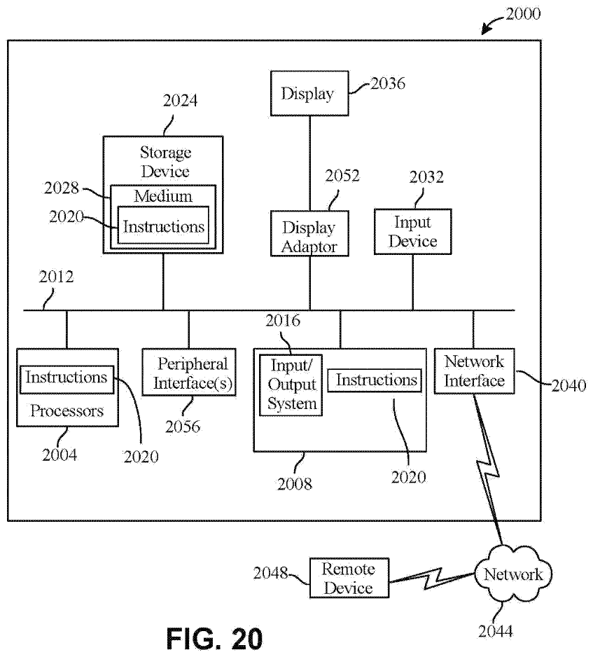

FIG. 20 shows a diagrammatic representation of one embodiment of a computing device in the exemplary form of a computer system 2000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2000 includes a processor 2004 and a memory 2008 that communicate with each other, and with other components, via a bus 2012. Bus 2012 may include any of several types of bus structures including, but not limited to, a memory bus, a memory controller, a peripheral bus, a local bus, and any combinations thereof, using any of a variety of bus architectures.

Processor 2004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2004 may be organized according to Von Neumann and/or Harvard architecture as a non-limiting example. Processor 2004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 2008 may include various components (e.g., machine-readable media) including, but not limited to, a random-access memory component, a read only component, and any combinations thereof. In one example, a basic input/output system 2016 (BIOS), including basic routines that help to transfer information between elements within computer system 2000, such as during start-up, may be stored in memory 2008. Memory 2008 may also include (e.g., stored on one or more machine-readable media) instructions (e.g., software) 2020 embodying any one or more of the aspects and/or methodologies of the present disclosure. In another example, memory 2008 may further include any number of program modules including, but not limited to, an operating system, one or more application programs, other program modules, program data, and any combinations thereof. Memory 2008 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 2000 may also include a storage device 2024. Examples of a storage device (e.g., storage device 2024) include, but are not limited to, a hard disk drive, a magnetic disk drive, an optical disc drive in combination with an optical medium, a solid-state memory device, and any combinations thereof. Storage device 2024 may be connected to bus 2012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 2024 (or one or more components thereof) may be removably interfaced with computer system 2000 (e.g., via an external port connector (not shown)). Particularly, storage device 2024 and an associated machine-readable medium 2028 may provide nonvolatile and/or volatile storage of machine-readable instructions, data structures, program modules, and/or other data for computer system 2000. In some embodiments, storage device 2024 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or more remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 2020 may reside, completely or partially, within machine-readable medium 2028. In another example, software 2020 may reside, completely or partially, within processor 2004.

Computer system 2000 may also include an input device 2032. In one example, a user of computer system 2000 may enter commands and/or other information into computer system 2000 via input device 2032. Examples of an input device 2032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2032 may be interfaced to bus 2012 via any of a variety of interfaces (not shown) including, but not limited to, a serial interface, a parallel interface, a game port, a USB interface, a FIREWIRE interface, a direct interface to bus 2012, and any combinations thereof. Input device 2032 may include a touch screen interface that may be a part of or separate from display 2036, discussed further below. Input device 2032 may be utilized as a user selection device for selecting one or more graphical representations in a graphical interface as described above.

A user may also input commands and/or other information to computer system 2000 via storage device 2024 (e.g., a removable disk drive, a flash drive, etc.) and/or network interface device 2040. A network interface device, such as network interface device 2040, may be utilized for connecting computer system 2000 to one or more of a variety of networks, such as network 2044, and one or more remote devices 2048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2044, may employ a wired and/or a wireless mode of communication. In general, any network topology may be used. Information (e.g., data, software 2020, etc.) may be communicated to and/or from computer system 2000 via network interface device 2040.

Computer system 2000 may further include a video display adapter 2052 for communicating a displayable image to a display device, such as display 2036. Examples of a display device include, but are not limited to, a liquid crystal display (LCD), a cathode ray tube (CRT), a plasma display, a light emitting diode (LED) display, and any combinations thereof. Display adapter 2052 and display 2036 may be utilized in combination with processor 2004 to provide graphical representations of aspects of the present disclosure. In addition to a display device, computer system 2000 may include one or more other peripheral output devices including, but not limited to, an audio speaker, a printer, and any combinations thereof. Such peripheral output devices may be connected to bus 2012 via a peripheral interface 2056. Examples of a peripheral interface include, but are not limited to, a serial port, a USB connection, a FIREWIRE connection, a parallel connection, and any combinations thereof.

Further referring to FIG. 20, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 20, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 20, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 2000, processor 2004, and memory 2008 may be virtualized; that is, a virtual machine and/or container may interact directly with such computing system 2000, processor 2004, and/or memory 2008, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 2004 comprises a plurality of processors and/or processor cores, virtualization may, in some cases, simulate or emulate a single (virtual) processor whose functions are allocated to one or more of the plurality of processors and/or processor cores. In this case, while processor 2004 may be said to be virtualized, the processor 2004, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for data processing, the apparatus comprising:
an audio input component configured to detect audio data;
a display component;
at least a processor; and
a memory communicatively connected to the at least a processor, wherein the memory contains instructions configuring the at least a processor to:
receive the audio data from the audio input component;
generate text content as a function of the audio data;
determine a display target for at least a portion of the text content; and
display at least a portion of the text content by the display component at the display target.

2. The apparatus of claim 1, wherein generating the text content as a function of the audio data further comprises translating, using a multimodal model or a generative artificial intelligence model, at least a portion of the text content comprising transcript text, wherein at least a portion of the transcript text in a source language is translated to obtain translated text in a target language.

3. The apparatus of claim 2, wherein the memory contains instructions further configuring the at least a processor to:
route the transcript text to a first output device; and
route the translated text to a second output device, wherein the first output device comprises the display component of smart glasses and the second output device comprises an audio output device of a companion device.

4. The apparatus of claim 1, wherein:
the apparatus further comprises smart glasses; and
at least one of the audio input component and the display component is arranged on the smart glasses.

5. The apparatus of claim 4, wherein:
the apparatus further comprises a companion device communicatively connected to the smart glasses; and
one of the audio input component and the display component is arranged on the companion device.

6. The apparatus of claim 1, wherein determining the display target comprises determining a device on which the at least a portion of the text content is to be displayed.

7. The apparatus of claim 1, wherein the memory contains instructions further configuring the at least a processor to generate and provide an audio output of at least a portion of the text content using an audio output component of the display component.

8. The apparatus of claim 1, wherein the display component comprises a visual output component.

9. The apparatus of claim 1, wherein the memory contains instructions further configuring the at least a processor to:
generate feedback as a function of the text content; and
display the feedback by the display component.

10. The apparatus of claim 1, wherein displaying the at least a portion of the text content comprises sending the at least a portion of the text content to the display component using wireless communication.

11. The apparatus of claim 2, wherein the memory contains instructions further configuring the at least a processor to:
route the transcript text to a first output device; and
route the translation to a second output device, wherein the first output device comprises the display component of smart glasses and the second output device comprises an audio output device of a companion device.

12. The apparatus of claim 11, wherein the display component of the smart glasses is removably coupled to the smart glasses.

13. The apparatus of claim 2, wherein the apparatus further comprises a speaker configured to playback the audio data, or a corresponding speech based on the transcript text or the translated text.

14. The apparatus of claim 1, wherein the apparatus further comprises a camera configured to acquire visual data, and wherein the at least a processor is configured to implement a hybrid audio-visual mode in which the audio data and the visual data are used as input data for generating the text content.

15. A method of data processing, the method comprising:
detecting, using an audio input component, audio data;
receiving, using at least a processor, the audio data from the audio input component;
generating, using the at least a processor, text content as a function of the audio data;
determining, using the at least a processor, a display target for at least a portion of the text content; and
displaying, using the at least a processor, at least a portion of the text content by a display component at the display target.

16. The method of claim 15, wherein generating the text content as a function of the audio data further comprises translating, using a multimodal model or a generative artificial intelligence model, at least a portion of the text content comprising transcript text, wherein at least a portion of the transcript text in a source language is translated to obtain translated text in a target language.

17. The method of claim 16, further comprising:
routing, using the at least a processor, the transcript text to a first output device; and
routing, using the at least a processor, the translated text to a second output device, wherein the first output device comprises the display component of smart glasses and the second output device comprises an audio output device of a companion device.

18. The method of claim 15, wherein the audio input component or the display component is arranged on smart glasses.

19. The method of claim 17, wherein:
the smart glasses are communicatively connected to a companion device; and
one of the audio input component and the display component is arranged on the companion device.

20. The method of claim 15, wherein determining the display target comprises determining a device on which the at least a portion of the text content is to be displayed.

21. The method of claim 15, further comprising:
generating and providing, using the at least a processor, an audio output of at least a portion of the text content using an audio output component of the display component.

22. The method of claim 15, wherein the display component comprises a visual output component.

23. The method of claim 17, further comprising:
generating, by the at least a processor, feedback as a function of the text content; and
displaying, by the at least a processor, the feedback by the display component.

24. The method of claim 15, wherein displaying the at least a portion of the text content comprises sending the at least a portion of the text content to the display component using wireless communication.

25. The method of claim 16, wherein the at least a processor is configured to playback the audio data, or a corresponding speech based on the transcript text or the translated text via a speaker.

26. The method of claim 15, wherein the at least a processor is configured to acquire visual data via a camera, and wherein the at least a processor is further configured to implement a hybrid audio-visual mode in which the audio data and the visual data are used as input data for generating the text content.
